(19) United States
(12) Patent Application Publication
(10) Pub. No.: US 2026/0251247 A1
(43) Pub. Date: Aug. 27, 2026

(54) Grooved Pipe Element and Coupling

(71) Applicant: VICTAULIC COMPANY, Easton, PA (US)

(72) Inventors: Christopher A. Richards, Saylorsburg, PA (US); Michael R. Novitsky, Slatington, PA (US)

(21) Appl. No.: 19/546,325

(22) Filed: Feb. 21, 2026

Related U.S. Application Data
(60) Provisional application No. 63/761,629, filed on Feb. 21, 2025.

(51) Int. Cl. F16L 23/08; F16L 23/22

(52) U.S. Cl. CPC F16L 23/08; F16L 23/22

(57) ABSTRACT

A pipe element has an endform comprising a circumferential groove and a bead. The groove is defined by a first groove side surface, a second groove side surface, and a floor surface. The bead has a summit and a first bead side surface positioned between the second groove side surface and the summit. When a pipe element is inserted into a coupling, the bead engages a portion of the coupling to position and align the arcuate projection with the groove, facilitating assembly without manual alignment.

### CROSS REFERENCE TO RELATED APPLICATIONS

This application is based upon and claims priority to US Provisional Application No. 63/761,629, filed February 21, 2025, which application is hereby incorporated by reference in its entirety.

### FIELD

This disclosure concerns improved endforms for pipe elements joined by grooved mechanical couplings and couplings compatible with improved endforms, and grooved coupling joints.

### BACKGROUND

Grooved mechanical pipe couplings are used to join pipe elements in end to end relation. Grooved pipe elements have a circumferential groove formed in an outer surface of the pipe element proximate an end thereof. A mechanical coupling comprises segments that are attached to one another to surround the ends of the pipe elements to be joined. Each segment has an arcuate projection, also known as a key, that projects radially inwardly and engages the groove of the pipe element. A seal or gasket is typically positioned within the coupling to provide a fluid-tight seal between the pipe elements. Grooved couplings that are pre-assembled such that the segments are attached in spaced relation to allow the insertion of a pipe element often have gaskets that have a radially-inwardly projecting tongue designed to serve as a "stop" that locates the keys of the couplings relative to the groove such that the assembly can be properly installed. The tongue engages the pipe element upon insertion and prevents the pipe element from moving too far into the coupling, thereby positioning the groove in alignment with the keys of the coupling segments. Couplings without such tongues rely on manual alignment of the coupling keys with the groove, which may result in increased misassembly. Improper alignment of the keys and grooves can lead to joint failure, leakage, or reduced joint integrity.

However, the tongue may increase the width of the gasket, which increases the width of the housings and generally makes the couplings heavier and harder to use. The increased width of the coupling may also be undesirable in applications where space is limited or where a more compact coupling is preferred. Additionally, the tongues add complexity and cost to the gasket design and manufacturing process.

In view of the limitations and drawbacks of the above couplings and approaches, there is a need for grooved couplings and pipe elements that can be properly aligned without using ring seals with tongues or center legs and without necessitating manual alignment.

### SUMMARY

In one aspect, an example pipe element has a sidewall surrounding a longitudinal axis and defining a bore. The longitudinal axis is a central axis of the pipe element. The sidewall has an outer surface. The sidewall comprises an endform and a tubular portion connected to the endform. The endform extends from an end of the pipe element to the tubular portion. The endform comprises a groove defined by the outer surface. The groove extends circumferentially around the bore. The groove comprises a first groove side surface, a second groove side surface facing the first groove side surface and in spaced apart relation from the first groove side surface along the longitudinal axis, and a floor surface contiguous with the first groove side surface and the second groove side surface. The first groove side surface is positioned between the end of the pipe element and the second groove side surface. The endform further comprises a bead defined by the outer surface. The bead extends circumferentially around the bore. The bead is adjacent or contiguous with the groove. The groove is positioned between the end of the pipe element and the bead. The bead comprises a first bead side surface and a summit. The first bead side surface is positioned between the summit and the second groove side surface. A radius of the summit measured from the longitudinal axis is a maximum radius of the outer surface of a portion of the sidewall extending from the end of the pipe element to the summit measured from the longitudinal axis.

In another aspect, an example pipe element and an example coupling in a preassembled state are provided in combination. The pipe element has a sidewall surrounding a longitudinal axis and defining a bore. The longitudinal axis is a central axis of the pipe element. The sidewall has an outer surface. The sidewall comprises an endform and a tubular portion connected to the endform. The endform extends from an end of the pipe element to the tubular portion. The endform comprises a groove defined by the outer surface. The groove extends circumferentially around the bore. The groove comprises a first groove side surface, a second groove side surface facing the first groove side surface and in spaced apart relation from the first groove side surface, and a floor surface contiguous with the first groove side surface and the second groove side surface. The first groove side surface is positioned between the end of the pipe element and the second groove side surface. The endform further comprises a bead defined by the outer surface. The bead extends circumferentially around the bore. The bead is adjacent or contiguous with the groove. The bead comprises a first bead side surface and a summit. The first bead side surface is positioned between the summit and the second groove side surface. A radius of the summit measured from the longitudinal axis is a maximum radius of the outer surface of a portion of the sidewall extending from the end of the pipe element to the summit measured from the longitudinal axis. The coupling comprises a plurality of segments attached to one another end to end surrounding a central space. The coupling further comprises attachment members positioned at each end of the segments for attaching the segments to one another in the preassembled state. In the preassembled state, the plurality of segments are supported in spaced relation while attached to one another to allow insertion of the pipe element into the central space. The coupling further comprises an arcuate projection positioned on a side of each of the segments and configured to engage with the groove. The arcuate projection projects radially inwardly from the side.In another aspect, an example method of assembling a combination of a pipe element and a coupling is provided. The pipe element has a sidewall surrounding a longitudinal axis and defining a bore. The longitudinal axis is a central axis of the pipe element. The sidewall has an outer surface comprising an endform proximate an end of the pipe element. The endform comprises a groove defined by the outer surface. The groove extends circumferentially around the bore. The endform further comprises a bead defined by the outer surface. The bead is adjacent or contiguous with the groove. The coupling comprises a plurality of segments attached to one another end to end in a preassembled state surrounding a central space. In the preassembled state, the plurality of segments are supported in spaced relation while attached to one another to allow insertion of the pipe element into the central space. The coupling further comprises attachment members for attaching the segments to one another. The coupling further comprises an arcuate projection positioned on a side of each of the segments. The arcuate projection projects radially inwardly from the side. The method comprises inserting the pipe element end first into the central space of the coupling in the preassembled state until at least one of the groove and the bead engages the arcuate projection.

In another aspect, an example method of forming a pipe element is provided. The pipe element has a sidewall surrounding a longitudinal axis and defining a bore. The longitudinal axis is a central axis of the pipe element. The sidewall has an outer surface and an inner surface. The method comprises positioning the inner surface of the pipe element on an inner roller of a roller set. The inner roller comprises an inner roller body rotatable about a second axis. The method further comprises moving an outer roller of the roller set into contact with the outer surface of the pipe element. The outer roller comprises an outer roller body rotatable about a first axis. The method further comprises rotating the inner roller, thereby rotating the pipe element and the outer roller. The method further comprises forcing the inner and outer rollers toward one another to deform the pipe element to form an endform. The endform comprises a groove defined by the outer surface proximate an end of the pipe element. The groove extends circumferentially around the bore. The groove comprises a first groove side surface, a second groove side surface facing the first groove side surface and in spaced apart relation from the first groove side surface, and a floor surface contiguous with the first groove side surface and the second groove side surface. The endform further comprises a bead defined by the outer surface. The bead is adjacent or contiguous with the groove. The bead comprises a first bead side surface and a summit. The groove is positioned between the end of the pipe element and the bead. The first bead side surface is positioned between the summit and the second groove side surface.

### BRIEF DESCRIPTION OF THE DRAWINGS

FIG. 1 is an isometric view of an example coupling joining together example pipe elements according to the disclosure;

FIG. 2 is an isometric view of an example pipe element according to the disclosure;

FIG. 3 is an isometric view of an example pipe element that is an example elbow fitting according to the disclosure;

FIG. 4 is an isometric view of an example pipe element that is an example tee fitting according to the disclosure;

FIG. 5 is a front side view of the pipe element shown in FIG. 2;

FIG. 6 is a front side view of a second embodiment of the pipe element;

FIG. 7 is a front side view of a third embodiment of the pipe element;

FIG. 8 is a front side view of a fourth embodiment of the pipe element;

FIG. 9 is a front side view of a fifth embodiment of the pipe element;

FIG. 10 is a left end view of the pipe element shown in FIG. 2;

FIG. 11 is a cross-sectional view of the pipe element taken along section line 11-11 in FIG. 10;

FIG. 12 is an isometric view of an example coupling according to the disclosure;

FIG. 13 is a front side view of the coupling shown in FIG. 12;

FIG. 14 is a right end view of the coupling shown in FIG. 12;

FIG. 15 is a top plan view of the coupling shown in FIG. 12;

FIG. 16 is a front side view of a second embodiment of the coupling;

FIG. 17 is a front side view of a third embodiment of the coupling;

FIG. 18 shows a cross-sectional view of a portion of an example combination coupling and pipe elements with the coupling in a preassembled state in an initial condition;

FIG. 19 shows a cross-sectional view of a portion of an example combination coupling and pipe elements with the coupling in a preassembled state in an initial condition;

FIG. 20 shows a cross-sectional view of a portion of the example combination coupling and pipe elements with the coupling in an initial condition;

FIG. 21 shows a cross sectional view of a portion of the example combination coupling and pipe elements with the coupling in a tightened condition;

FIG. 22 is an isometric view of a fourth example coupling according to the disclosure;

FIG. 23 is a front side view of the coupling shown in FIG. 22;

FIG. 24 is a right end view of the coupling shown in FIG. 22;

FIG. 25 is a top plan view of the coupling shown in FIG. 22;

FIG. 26 is an isometric view of the coupling shown in FIG. 22 joining together example pipe elements according to the disclosure;

FIG. 27 shows a side view of an example roller set and pipe element according to the disclosure; and

FIG. 28 shows a front view of an example pipe element according to the disclosure inserted end first into the central space of an example preassembled coupling according to the disclosure.

### DETAILED DESCRIPTION

The present disclosure can be understood more readily by reference to the accompanying detailed description, which includes examples, claims and drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “a channel” can represent disclosure of embodiments in which only a single channel is provided, and unless the context dictates otherwise, can also represent disclosure of embodiments in which a plurality of such channels are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each (e.g., A and B, A and C, B and C, or A, B, and C).

As used herein “pipe” or “pipe element” is intended to mean any fluid pipe-like component including, but not limited to, pipe stock, pipe fittings such as elbows, caps and tees, as well as fluid control components such as valves, reducers, strainers, restrictors, pressure regulators and the like. When a feature is described herein with respect to a “pipe” or a “pipe element,” it is understood that such description represents disclosure of that feature with respect to a specific form of “pipe” or “pipe element” as indicated above. For example, unless otherwise indicated, description of a feature with respect to a “pipe element” is intended to provide disclosure of a pipe fitting having the described feature.

As used herein, when referencing the point or region where two surfaces or features come together, the term “transition,” “transition region,” or “transitions” means a change from one surface or portion to another surface or portion via practical geometric forms such as arcs, fillets, chamfers, and other more generalized concave or convex features, inflections, or blends between the surfaces or features, it being understood that perfectly flat surfaces or sharp corners may not be practical and in many cases undesirable. The term “transition,” “transition region,” or “transitions” may comprise edge portions at either or both ends of surfaces or features described herein.

As used herein, the term “contiguous” means that two surfaces are connected, either directly or through a transition region. Two contiguous surfaces may share a common edge or boundary, or may be connected by a transition region therebetween. As described herein, the transition region may comprise a radiused surface, a chamfered surface, a fillet, or other transitional geometry connecting the two surfaces. For example, a first surface and a second surface that are contiguous may meet at an apparently sharp edge, or may be connected by a curved or radiused transition region extending between the first surface and the second surface. In some aspects, a transition region connecting two contiguous surfaces may have a length or peripheral dimension that is less than a length or peripheral dimension of either of the two surfaces being connected. In some aspects, and without limitation, a transition region connecting two contiguous surfaces may have a length or peripheral dimension of less than about 10 mm, less than about 5 mm, less than about 3 mm, or less than about 1 mm. These dimensions are provided by way of example only and are not intended to limit the scope of the term “contiguous” or the dimensions of any transition region. The term “contiguous” does not require that the two surfaces be coplanar or tangent to one another.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially parallel”) or “generally” (e.g., “generally planar”) should be understood to include embodiments in which angles are within ten degrees, or within five degrees, or within one degree of the stated position or orientation.

The word “or” as used herein means any one member of a particular list and, in alternative embodiments, unless context dictates otherwise, can include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the device, systems, and associated methods can be implemented and used without employing these specific details. Indeed, the device, systems, and associated methods can be placed into practice by modifying the illustrated device, systems, and associated methods and may be used in conjunction with any other apparatus and techniques conventionally used in the industry.

### Overview

Various embodiments of pipe elements, couplings, combinations, and corresponding methods are disclosed. As further discussed herein, it is contemplated that the disclosed pipe elements, and/or couplings can be used to address or improve upon one or more of the deficiencies of existing grooved coupling joints. For example, it is contemplated that the disclosure can allow for or provide preassembled grooved couplings that do not have tongues but which cooperate with pipe elements that automatically align keys to the groove. It is further contemplated that such grooved couplings can decrease the required width of the gasket and coupling, thereby leading to decreased coupling weight and improved ease of use.

The grooved mechanical pipe couplings disclosed herein are used to join pipe elements in end to end relation. The example grooved pipe elements disclosed herein have endforms comprising a circumferential groove and a bead formed in an outer surface of the pipe element proximate an end thereof. An example mechanical coupling disclosed herein comprises segments that are configured to attach to one another to surround the ends of the pipe elements to be joined. Each segment has an arcuate projection, also known as a key, that projects radially inwardly and engages the groove of the pipe element. A seal or gasket is typically positioned within the coupling to provide a fluid-tight seal between the pipe elements.

The groove of the pipe element is positioned between the end of the pipe element and the bead. In exemplary configurations, the bead has a summit with a radius greater than any other radius of the outer surface of the endform from the end of the pipe element to the summit. The position of the bead facilitates the alignment of the groove relative to the arcuate projection of the coupling. Optionally, the bead of the pipe element is positioned adjacent (optionally, immediately adjacent) or contiguous with the groove. When a pipe element is inserted into a coupling in a preassembled state, the bead contacts a portion of the coupling, such as the arcuate projection, to position and align the arcuate projection with the groove, facilitating assembly without manual alignment. The geometry of the arcuate projection and the endform of the pipe element may therefore facilitate alignment and engagement between the groove and arcuate projection of a coupling without relying on contact between the pipe element and a tongue or center leg on the seal, and without requiring manual alignment of the arcuate projection and groove.

### Combination of Grooved Coupling and Pipe Elements

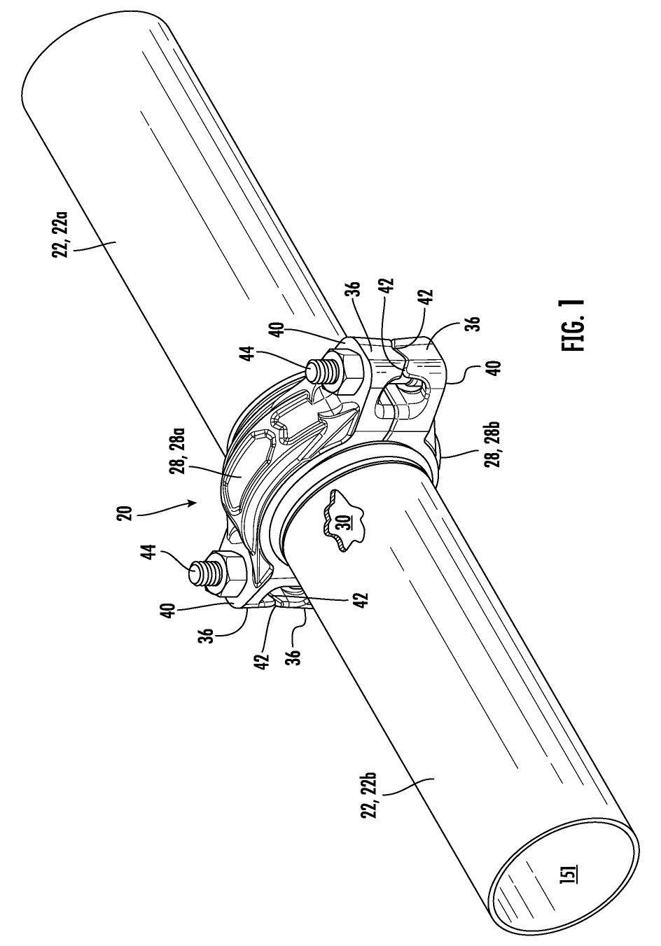

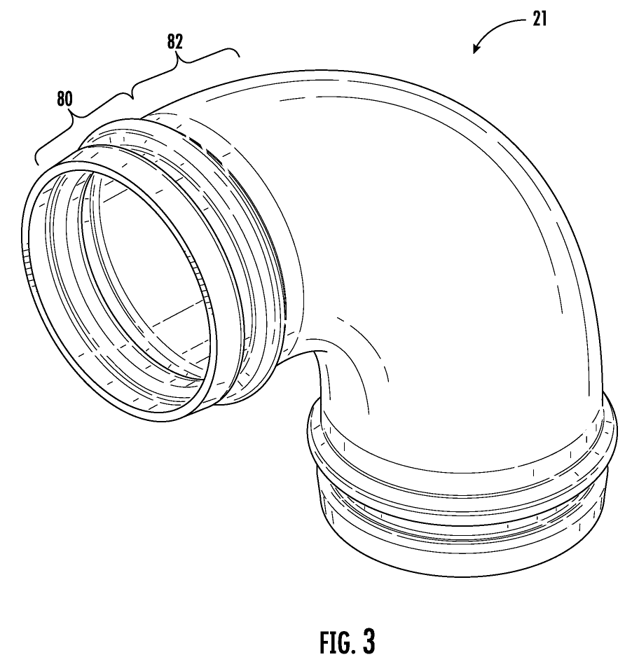

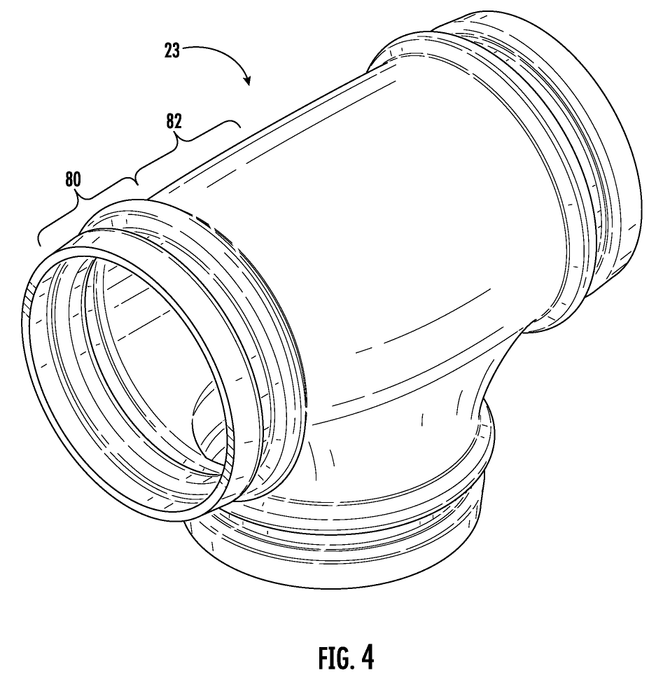

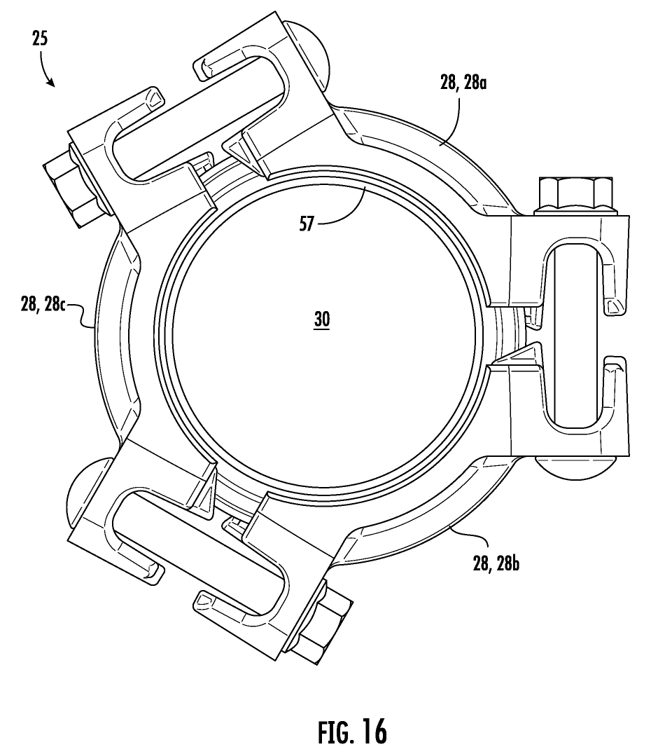

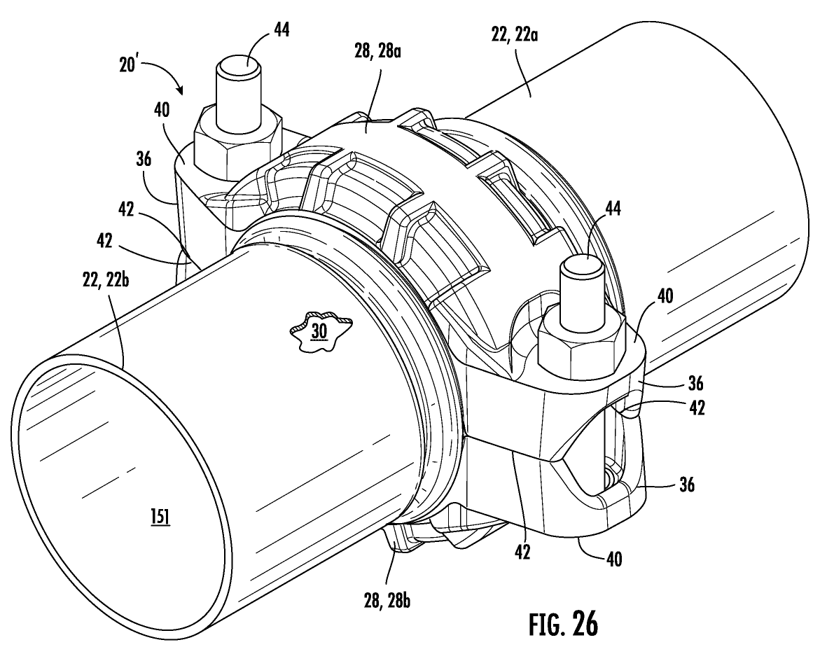

FIGS. 1 and 26 show an example grooved mechanical pipe coupling 20, 20’ according to the disclosure joining example pipe elements 22, in this example a first pipe element 22a and a second pipe element 22b. As previously defined, each pipe element 22 can be any fluid pipe-like component including, but not limited to, pipe stock, pipe fittings such as elbows (shown in FIG. 3), caps and tees (shown in FIG. 4), as well as fluid control components such as valves, reducers, strainers, restrictors, pressure regulators and the like. Coupling 20, 20’ comprises a plurality of segments 28, in this example a first segment 28a and a second segment 28b, configured to attach to one another end to end to surround a central space 30. The plurality of segments 28 are configured to attached to one another end to end to form a loop or annular structure around the central space 30. The plurality of segments 28 are configured to surround the ends of the pipe elements 22a, 22b. Attachment of the segments 28a, 28b to one another is effected by attachment members 36 positioned at each end of the segments 28a, 28b. Attachment members 36 are configured to draw the segments 28a, 28b together to a tightened condition as described herein to join the first pipe element 22a to the second pipe element 22b. Although coupling 20, 20’ is depicted with two segments, couplings according to the disclosure may comprise more than two segments. For example, FIG. 16 illustrates another example embodiment of a coupling 25 according to the invention. Coupling 25 shares many of the features of coupling 20, 20’ as described herein but comprises three segments 28 attached to one another end to end to surround and define the central space 30 for receiving the pipe element. The third segment 28c comprises the same or substantially the same features as the first and second segments 28a, 28b. Although coupling 25 has three segments 28, a coupling having more than three segments is also practical. For example, the coupling may comprise four segments as disclosed herein attached to one another end to end to surround and define the central space.

Exemplary pipe elements 22 and grooved pipe couplings 20, which can be provided and used together or independently of one another, are discussed further below.

### Pipe Elements

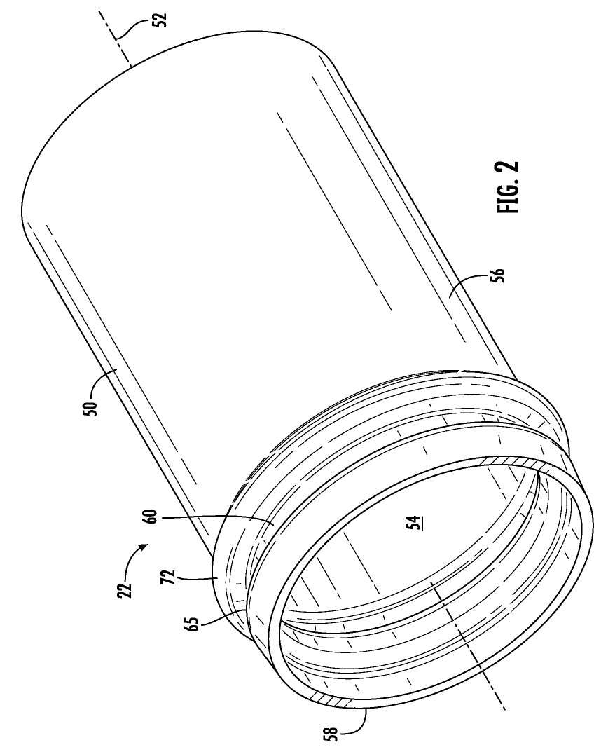

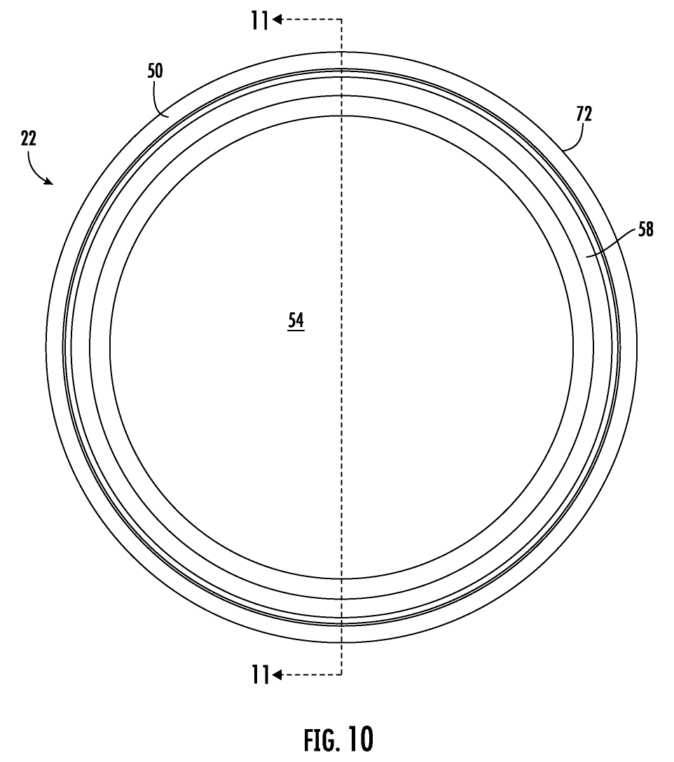

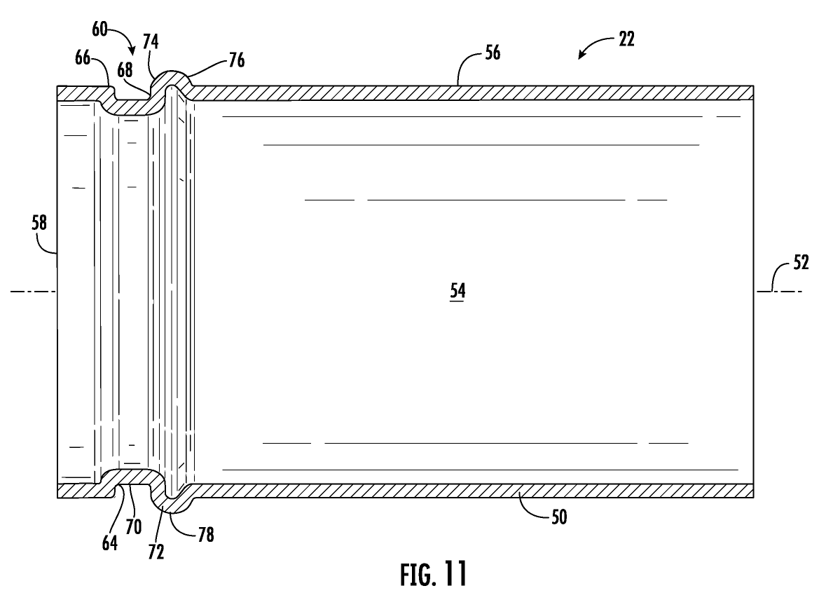

FIGS. 2 and 5-9 show an example pipe element 22. The pipe element 22 may be made of any conventional piping material, or other suitable materials, including malleable materials such as ferrous and nonferrous metals and polymers. Optionally, the pipe may be made of stainless steel. Optionally, pipe element 22 may be a thin wall pipe as understood in the industry, e.g., pipe that has a thinner wall than standard weight, Schedule 40 pipe, such as Schedule 10 pipe (as of the time of filing). The pipe element 22 comprises a sidewall 50 surrounding a longitudinal axis 52 and defining a bore 54 (see FIGS. 10 and 11). The longitudinal axis 52 is a central axis of the pipe element 22. The features of the sidewall 50, including the groove and bead described herein may be understood with reference to a cross-sectional plane including the longitudinal axis 52. The sidewall 50 has an outer surface 56. As used herein, the outer surface 56 refers to the outward-facing surface of the sidewall 50 and includes all portions of the outward-facing surface regardless of the local geometry. The outer surface 56 includes surfaces within the groove, surfaces of the bead, surfaces of the tubular portion, and any other outward-facing surfaces of the sidewall 50. For example, the floor surface and side surfaces of the groove are portions of the outer surface 56, even though these surfaces may be positioned at a smaller radius than other portions of the outer surface 56. Similarly, the summit of the bead is a portion of the outer surface 56, even though the summit may be positioned at a larger radius than other portions of the outer surface 56. Radii of features of the outer surface 56 described herein are measured from the longitudinal axis 52.

The sidewall 50 comprises an endform 80 which is a formed end portion of the pipe element 22. A tubular portion 82 of the sidewall 50 is connected to the endform 80. The tubular portion 82 may be positioned immediately adjacent the endform 80. The tubular portion 82 may be contiguous with the endform 80. The endform 80 may extend from an end 58 of the pipe element 22 to the tubular portion 82. The endform 80 comprises a groove 60 defined by the outer surface 56 and extending circumferentially around the bore 54 (shown in FIG. 11). The groove 60 is positioned proximate to the end 58 of the pipe element 22. As used herein to describe a location relative to an end of a pipe element, the term "proximate" means that said location is closer to the stated end than to the opposing end of the pipe element. Optionally, the term "proximate" can further indicate that said location is closer to the stated end than to a transverse plane that is perpendicular to a longitudinal axis of the pipe element and equidistant from the opposing ends of the pipe element. Similarly, the term "distant" as used herein to describe a location relative to an end of the pipe element 22 may be closer to the opposite end than the stated end.

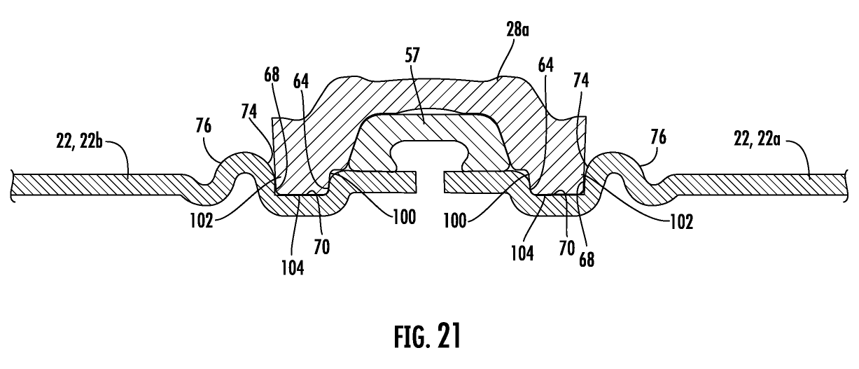

The groove 60 comprises a first groove side surface 64 terminating at a first end 65. As described herein, in some aspects, the first end 65 may be a summit 66. The first groove side surface 64 may include transitions at either or both of the ends of the surface 64. The first groove side surface 64 may be planar, concave, convex, or combinations thereof. For example, the first groove side surface 64 may have an S-shaped profile in a cross-sectional plane including the longitudinal axis 52. The groove 60 comprises a second groove side surface 68 facing the first groove side surface 64 and in spaced apart relation from the first groove side surface 64. The second groove side surface 68 may be planar, concave, convex, or combinations thereof. For example, the second groove side surface 68 may have an S-shaped profile in a cross-sectional plane including the longitudinal axis 52. The first groove side surface 64 is positioned between the end 58 of the pipe element 22 and the second groove side surface 68. A floor surface 70 is contiguous with the first groove side surface 64 and the second groove side surface 68. The second groove side surface 68 extends from the floor surface 70 to an upper end 69. The floor surface 70 has a width extending parallel or substantially parallel to the longitudinal axis 52. The floor surface 70 may be oriented parallel or substantially parallel (for example within 5° of parallel) to the longitudinal axis 52. Optionally, a radius 85 of the floor surface 70 measured from the longitudinal axis 52 may be less than any other radius measured from the longitudinal axis 52 to any part of the outer surface 56 of the endform 80. Optionally, the radius 85 of the floor surface 70 measured from the longitudinal axis 52 may be less than a minimum radius 103 of the outer surface 56 of the tubular portion 82 measured from the longitudinal axis 52. The first groove side surface 64 is oriented at a first groove side angle 88 relative to the floor surface 70. The second groove side surface 68 is oriented at a second groove side angle 90 relative to the floor surface 70. When the first groove side surface 64 and/or the second groove side surface 68 is non-planar, the first groove side angle 88 and/or the second groove side angle 90 may be measured relative to a line extending between the endpoints of the respective surface in a cross-sectional plane including the longitudinal axis 52. The first groove side angle 88 may be about 90° (for example, 90° or within 5° of 90°) or an obtuse angle. The second groove side angle 90 may be about 90° (for example, 90° or within 5° of 90°) or an obtuse angle. As shown in FIG. 21, the groove 60 is configured to receive an arcuate projection of a coupling. Optionally, the groove 60 may be configured to receive an arcuate projection of a coupling in a manner that provides for clearance between the mating surfaces of the arcuate projection and the side surfaces of the groove, 64, 68.

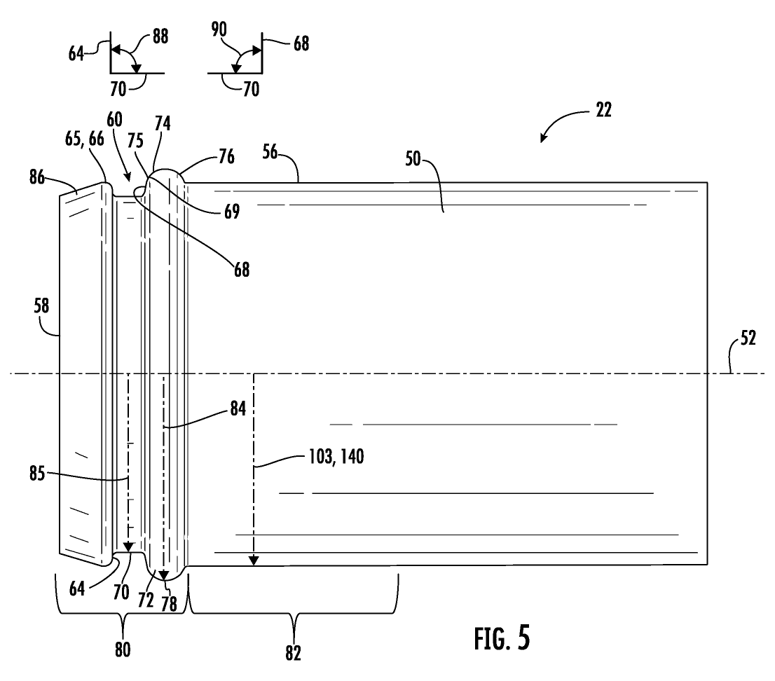

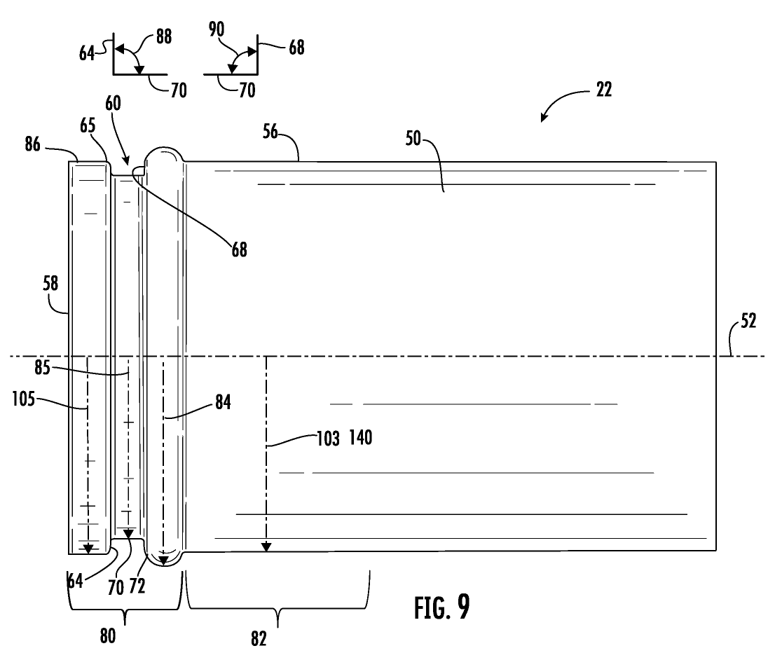

As shown in FIGS. 5-9, the endform 80 comprises a bead 72 defined by the outer surface 56. The bead 72 extends circumferentially around the bore 54 (shown in FIGS. 9-10). The bead 72 may be adjacent or contiguous with the groove 60. The location of bead 72 relative to groove 60 may be determined such that contact between the bead 72 and coupling 20, 20’ promotes alignment of arcuate projection 94 with groove 60 as described herein. Groove 60 is positioned between the end 58 of the pipe element 22 and the bead 72. The bead 72 comprises a first bead side surface 74 which transitions to a summit 78. The first bead side surface 74 is positioned between the summit 78 and the second groove side surface 68. The first bead side surface 74 may be contiguous with the second groove side surface 68 and may extend from the second groove side surface 68 to the summit 78. The first bead side surface 74 comprises a base end 75. The base end 75 of the first bead side surface 74 is closer to the floor surface 70 of the groove 60 than to the summit 78. The upper end 69 of the second groove side surface 68 and the base end 75 of the first bead side surface 74 may define a transition between the second groove side surface 68 and the first bead side surface 74. The transition may be a point of inflection where the curvature of the outer surface 56 changes direction. In some aspects, the upper end 69 of the second groove side surface 68 and the base end 75 of the first bead side surface 74 may be coincident, such that the transition is a distinct boundary between the second groove side surface 68 and the first bead side surface 74. In some aspects, the transition may comprise a radiused transition region connecting the upper end 69 of the second groove side surface 68 and the base end 75 of the first bead side surface 74. The second groove side surface 68 and the first bead side surface 74 may be oriented at the same or substantially the same angle relative to the floor surface 70. In some aspects, the second groove side surface 68 and the first bead side surface 74 may form a continuous or substantially continuous surface extending from the floor surface 70 to the summit 78.

A radius 84 of the summit 78 measured from the longitudinal axis 52 is a maximum radius of the outer surface 56 of a portion of the sidewall 50 between the summit 78 and the end 58 of pipe element 22. The radius 84 of the summit 78 measured from the longitudinal axis 52 may be greater than any other radius measured from the longitudinal axis 52 to any part of the outer surface 56 of the endform 80. The radius 84 of the summit 78 measured from the longitudinal axis 52 may be greater than a maximum radius 140 of the tubular portion 82 measured from the longitudinal axis 52.

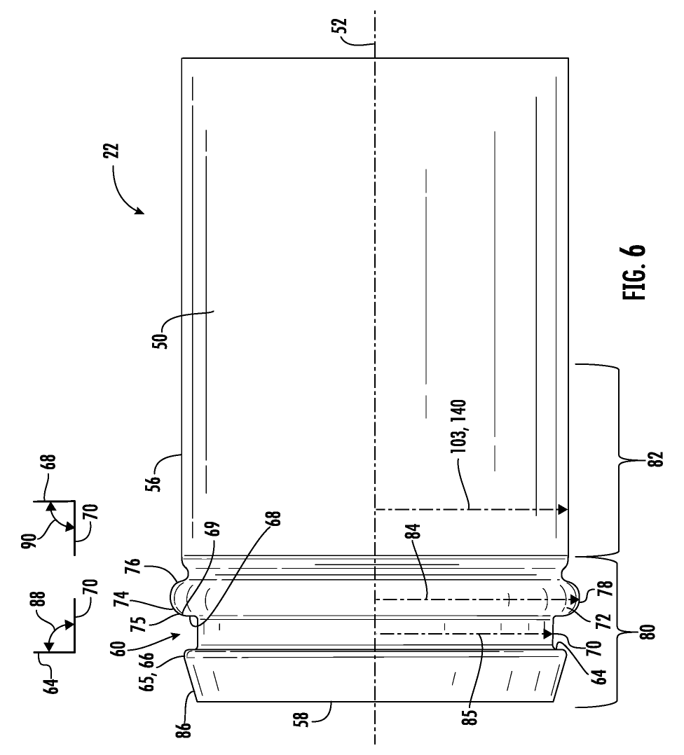

The bead 72 may further comprise a second bead side surface 76 extending from the summit 78 toward the tubular portion 82. The summit 78 is positioned between the first bead side surface 74 and the second bead side surface 76. The second bead side surface 76 has a larger radius measured from the longitudinal axis 52 at a point closer to the summit 78 than at a point farther from the summit 78. The tubular portion 82 may be contiguous with the second bead side surface 76. Optionally, as shown in FIG. 6, the endform 80 may comprise an indent 79 defined by the outer surface 56 which may extend circumferentially around the bore 54. The indent 79 may be contiguous with the second bead side surface 76. The indent 79 may be contiguous with the tubular portion 82. Optionally, the second bead side surface 76 may extend from the summit 78 to the indent 79. The presence or absence of indent 79 may be related to the method of manufacture of endform 80, and endforms 80 being formed by roll-forming may comprise indent 79. Endforms 80 may also be manufactured by other methods, such as casting, machining, or cold-working, and endforms 80 manufactured by these other methods may not include the indent 79, or optionally may include the indent 79. The indent 79 may be a tooling mark. The indent 79 may also provide evidence or guidance for proper installation of the pipe element relative to the coupling 20, 20’. Optionally, the indent 79 may comprise indicia that may identify the model number and/or source of the product. These other methods of manufacture of endforms 80, for instance casting, machining, and some types of cold working, may permit variations in the form of endform 80 that do not depart from the concepts herein disclosed; for instance these other methods may permit bead 72 or summit 78 to discontinuously extend around the bore 54.

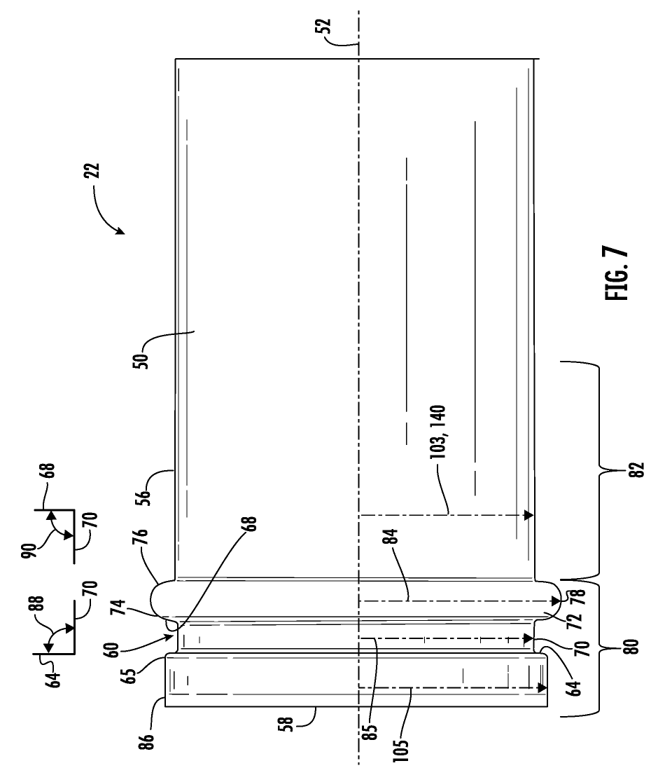

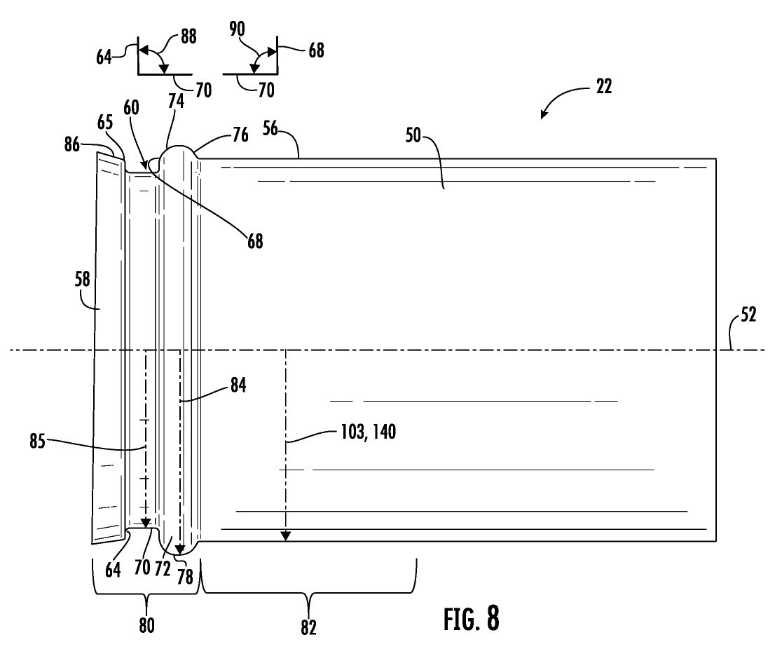

Optionally, in the example pipe element shown in FIGS. 6-9, the endform 80 further comprises a sealing surface 86 positioned between the first groove side surface 64 and the end 58 of the pipe element 22. The sealing surface 86 may extend from the first groove side surface 64 to the end 58 of the pipe element 22. Optionally, the sealing surface 86 may be contiguous with the first groove side surface 64. Optionally, as shown in FIGS. 7 and 9, the sealing surface 86 may be cylindrical or substantially cylindrical, and may have a radius 105 that is greater than the radius 85 of the floor surface 70 and less than the radius 84 of summit 78. For example, as shown in FIG. 9, the radius 105 of the cylindrical or substantially cylindrical surface 86 may be the same or substantially the same as the radius 103 of the tubular portion. Alternatively, as shown in FIG. 5, the sealing surface 86 may be frustoconical such that a radius of the sealing surface 86 measured from the longitudinal axis 52 at a first point may be less than a radius of the sealing surface 86 measured from the longitudinal axis 52 at a second point, wherein the first point is closer to the end 58 of the pipe element 22 than the second point to the end 58 of the pipe element 22. As shown in FIGS. 5 and 6, where the sealing surface 86 is frustoconical such that the sealing surface 86 tapers inwardly from the first groove side surface 64 towards the end 58 of the pipe element 22, the first end 65 of the first groove side surface 64 may be summit 66. The endform 80 may further comprise a sealing surface 86 positioned between the summit 66 and the end 58 of the pipe element 22. The sealing surface 86 may extend from the summit 66 to the end 58 of the pipe element 22. Optionally, as shown in FIG. 8, a radius of the sealing surface 86 measured from the longitudinal axis 52 at a first point may be larger than a radius of the sealing surface 86 measured from the longitudinal axis 52 at a second point, wherein the first point is closer to the end 58 of the pipe element 22 than the second point to the end 58 of the pipe element 22.

The geometry of the sealing surface 86 may be influenced by the roll forming process used to form the endform 80 and by the tolerances of the pipe element 22. The roll forming process may be configured to position the floor surface 70 of the groove 60 at a predetermined radius to interact appropriately with the arcuate projection of the coupling 20, 20’. When the pipe element 22 has a diameter on the smaller side of the tolerance range, the roll forming process may drive the floor surface 70 to the predetermined radius, and there may be more clearance between the pipe element 22 and the roller surface that forms the end 58 of the pipe element 22. In this case, the sealing surface 86 may flare or trumpet outwardly such that the sealing surface 86 has a larger radius at a point closer to the end 58 than at a point further from the end 58. When the pipe element 22 has a diameter on the larger side of the tolerance range, the sealing surface 86 may taper inwardly such that the sealing surface 86 has a smaller radius at a point closer to the end 58 than at a point further from the end 58. When the pipe element 22 has a diameter in the middle of the tolerance range, the sealing surface 86 may be cylindrical or substantially cylindrical. In some embodiments, the geometry of the sealing surface may have been selected for other practical or performance considerations; for instance, a frustoconical sealing surface 86 may promote easier installations into coupling 20, 20’ as the frustoconical sealing surface may act as a “lead in” that guides the pipe element 22 into coupling 20, 20’. The coupling 20, 20’ and gasket may be configured to seal against the sealing surface 86 regardless of whether the sealing surface 86 is frustoconical tapering inwardly, frustoconical tapering outwardly, cylindrical, or any combination thereof.

### Grooved Couplings

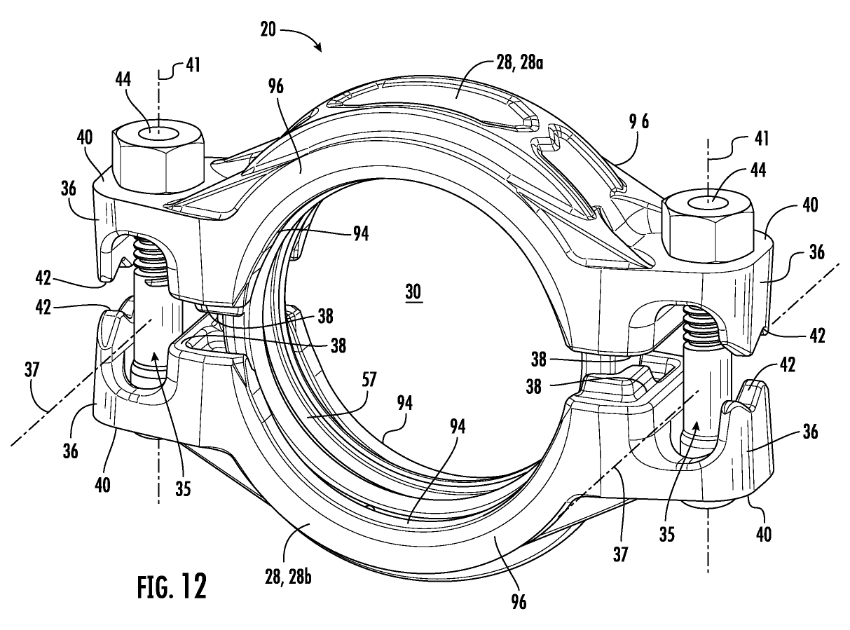

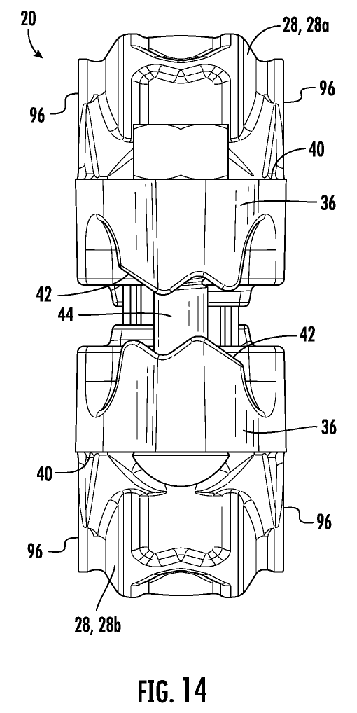

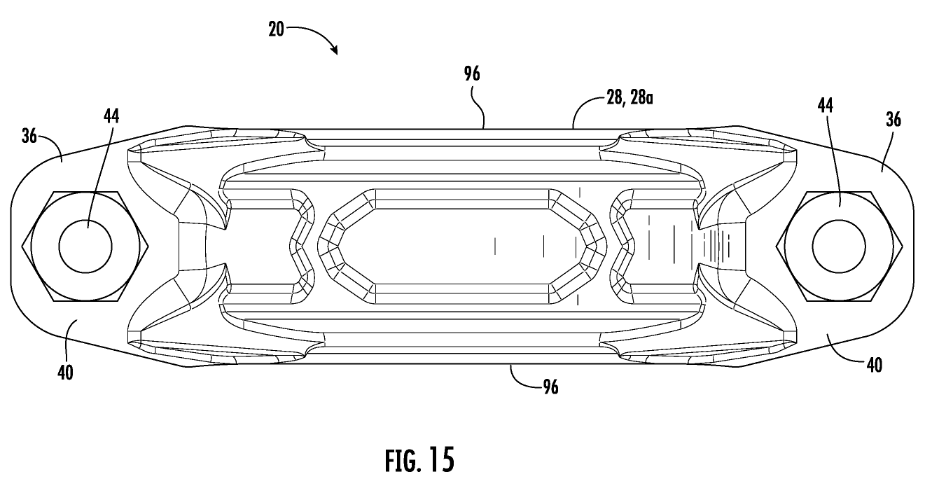

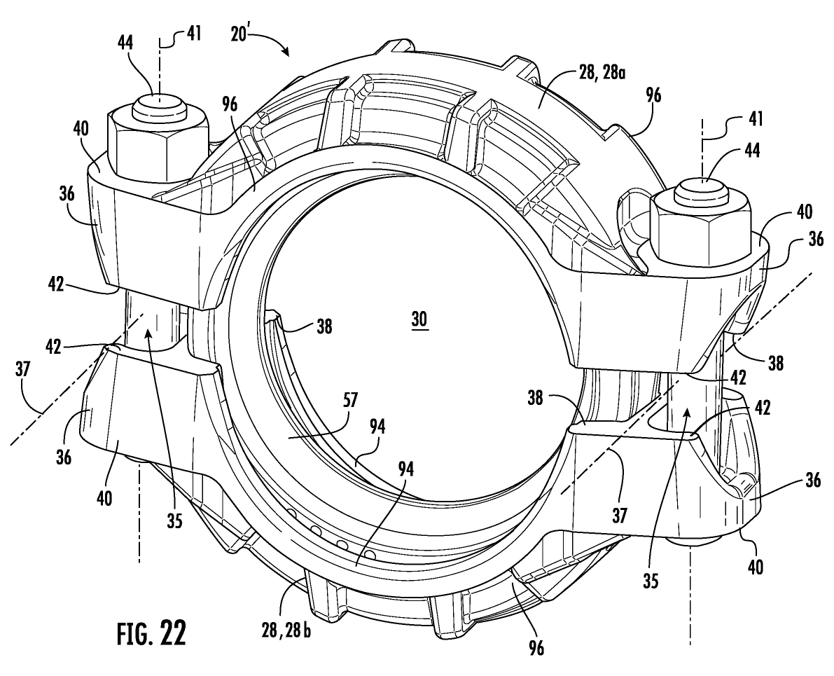

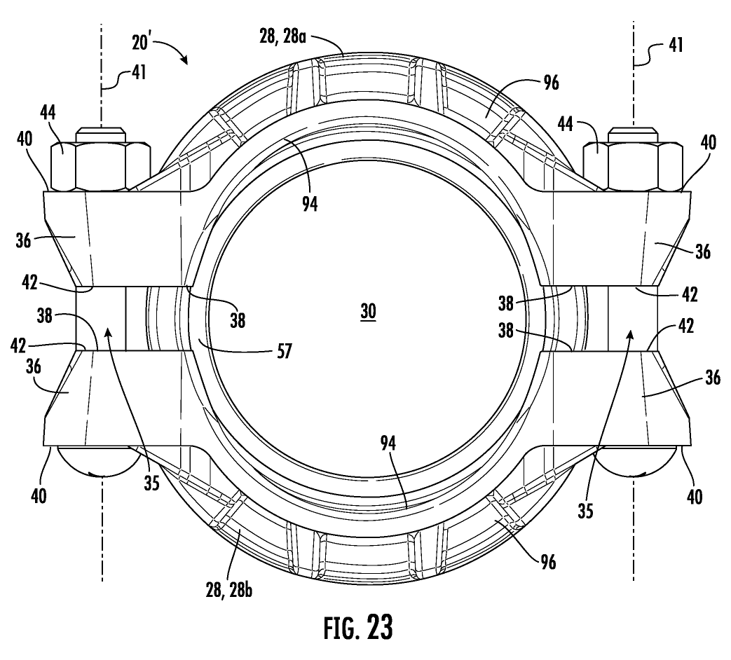

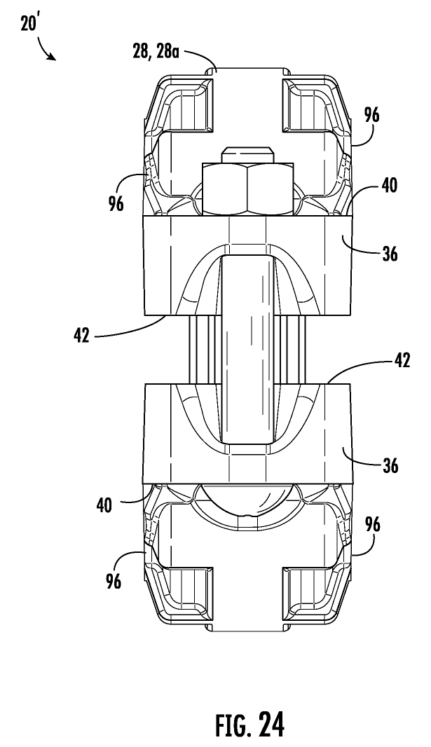

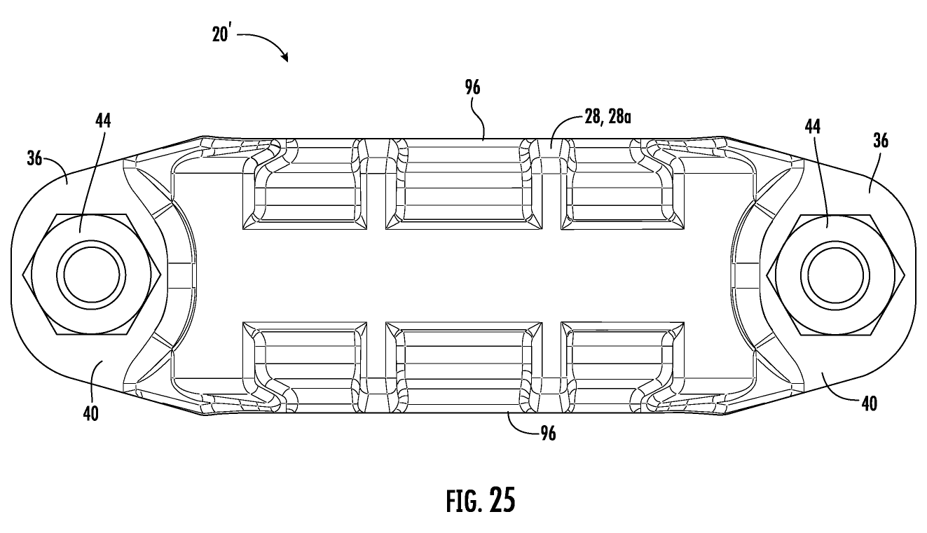

FIGS. 12-15 and 22-25 show an example grooved coupling 20, 20’. Couplings 20, 20’ according to the disclosure may take various forms. It is understood that the details of the coupling 20, 20’ described herein, including the arcuate projections (described herein), may be applied to various coupling configurations. FIGS. 12-15 show a first example coupling 20 according to the disclosure, and FIGS. 22-25 show a second example coupling 20’ according to the disclosure. The following description applies generally to couplings according to the disclosure (including coupling 20 and coupling 20’) unless otherwise indicated. The attachment members 36 of the coupling 20, 20’ comprise lugs 40, wherein respective lugs 40 may be attached via fasteners 44. At least one fastener 44 is an adjustably tightenable fastener such as the bolt and nut. As shown in FIGS. 12, 13, 22 and 23 each lug 40 comprises an inner bolt pad surface 38. Optionally, each lug 40 may comprise a stop surface 42. As shown in FIGS. 22 and 23, the stop surface 42 of coupling 20’ may be contiguous with the inner bolt pad surface 38. Alternatively, as shown in FIG. 12, each lug 40 of coupling 20 may define an opening 35 surrounding a first axis 37 oriented perpendicularly to a longitudinal axis 41 of the respective fastener 44 and extending through the lug 40 such that the stop surface 42 is spaced from the inner bolt pad surface 38. As shown in FIGS. 1 and 26, in a tightened condition, the stop surfaces 42 of coupling 20, 20’ on respective ends of the segments 28a, 28b may engage each other. As shown in FIG. 26, stop surfaces 42 of coupling 20’ are shown as flat pads; however, the disclosure is not so limited and the stop surfaces may take the form of slanted pads, tongue and recess, and other known interfaces. Optionally, the coupling 20’ may be in the tightened condition when the fasteners are tightened a predetermined amount. In the tightened condition, stop surfaces 42 may be separated by a gap. The gap may account for practical tolerance variations of the pipe element 22 and couplings 20 and 20’ as disclosed herein.

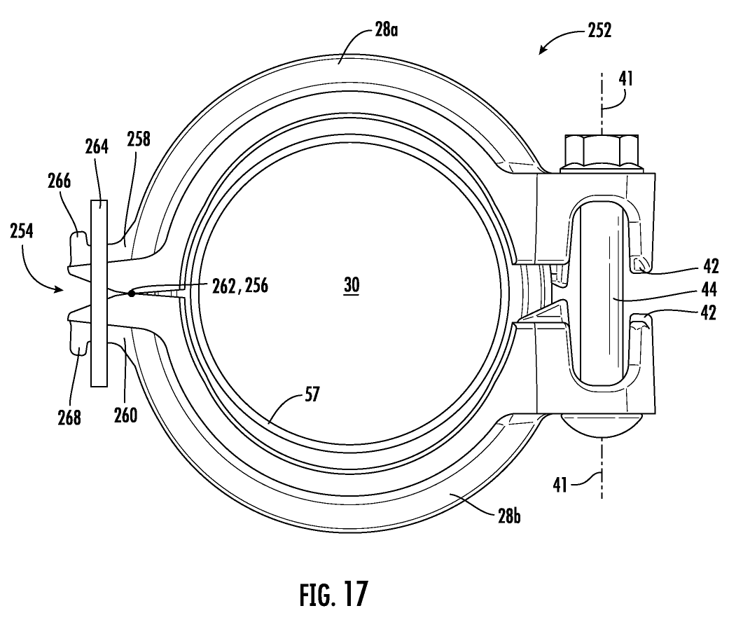

FIG. 17 illustrates another example embodiment of a coupling 252 according to the disclosure. Coupling 252 shares many of the features of coupling 20, 20’ as described above but substitutes a hinge 254 in place of a set of lugs 40. An end of each segment 28a and 28b is connected via the hinge 254 joining the first and second segments to one another. The hinge 254 defines a hinge axis 256 oriented transversely to the longitudinal axis 41 of the first fastener 44. The first and second segments 28a and 28b are pivotable about the hinge axis 256. Adjusting the fastener 44 pivots and thereby draws the first segment 28a and the second segment 28b toward one another. Optionally, the coupling 252 may include stop surfaces 42. Optionally, engagement between the stop surfaces 42 on the lugs 40 arrests rotation of the segments 28a, 28b relative to one another. In this example embodiment, hinge 254 comprises cantilevers 258, 260 engaging one another at a fulcrum 262. Cantilevers 258, 260 are joined by a ring 264, retained by projecting heads 266, 268 on each cantilever. Other forms of hinged joints, such as saddle and stirrup hinges, pinned hinges, cast hinges, and the like, are also contemplated.

### Formation of Joints

The coupling 20, 20’ comprises a ring seal 57 configured to be captured and compressed between the segment 28a, 28b and the pipe elements 22a, 22b (see FIGS. 12, 13, and 16-23) when the segments 28a, 28b are drawn toward one another and into engagement with the pipe elements 22a, 22b to form a fluid tight joint. Optionally, the ring seal 57 does not comprise a tongue or center leg.

In exemplary configurations, as shown in FIGS. 12-14, 16-17, and 22-24, the plurality of segments 28a, 28b are attached to one another end to end in a preassembled state. In the preassembled state, the plurality of segments 28a, 28b are supported in spaced relation while attached to one another to allow insertion of the pipe element 22 into the central space 30. The ring seal 57 may support the plurality of segments 28a, 28b in the preassembled state. One or more fasteners 44 may hold the segments 28a, 28b together and against the ring seal 57, which has sufficient stiffness to support the segments in the preassembled state, although other methods for maintaining the segments in a preassembled state, such as spacers, and spring-like elements, may be employed.

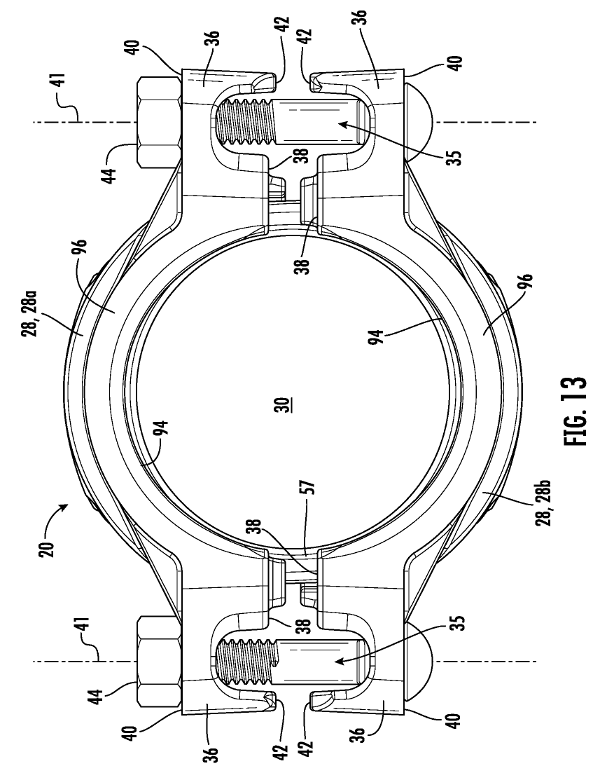

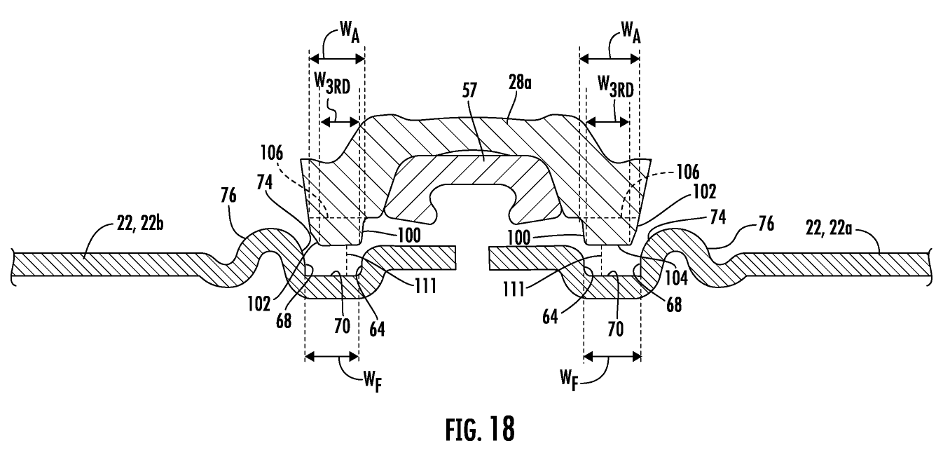

As further disclosed herein, an arcuate projection is positioned on at least one side 96 (e.g., both sides) of each of the segments 28a, 28b and is configured to engage with the groove 60. Thus, the coupling 20, 20’ has a plurality of arcuate projections (e.g., with two arcuate projections on each segment of the coupling). As shown in FIGS. 13 and 22, an exemplary arcuate projection 94 projects radially inwardly from the respective side 96 of each segment 28a, 28b. As shown in FIG. 18, the arcuate projection comprises a first mating surface 100. The first mating surface 100 may extend radially inwardly towards the central space 30 from the side of the segment 28a, 28b. The first mating surface 100 may be configured to engage the first groove side surface 64. The arcuate projection comprises a second mating surface 102. The second mating surface 102 may extend radially inwardly towards the central space 30 from the side of the segment 28a, 28b. The second mating surface 102 may be configured to engage the second groove side surface 68. The second mating surface 102 faces away from the first mating surface 100. The arcuate projection 94 comprises a third mating surface 104 positioned between and contiguous with the first mating surface 100 and the second mating surface 102. The third mating surface 104 may extend along the length of the arcuate projection. The third mating surface 104 faces the central space 30. As shown in FIG. 18, the first mating surface 100 may taper towards the second mating surface 102 and/or the second mating surface 102 may taper towards the first mating surface 100 such that a width W_{A} of the base 106 of the arcuate projection 94 is wider than a width W_{3RD} of the third mating surface 104. However, the disclosure is not so limiting and the first and second mating surfaces of the arcuate projections disclosed herein may be oriented at the same angles relative to one another, or at different angles. Either the first mating surface or the second mating surface may be oriented at an angle of about 90° relative to the axis 52 of pipe element 22. Except where otherwise indicated, it is contemplated that a “taper” or a “tapered” portion/surface can refer to any gradual decrease or narrowing in width or diameter. Optionally, the “taper” or “tapered” portion/surface can be a consistent/constant taper moving along a given length (e.g., a taper at a fixed angle). The width W_{3RD} of the third mating surface 104 extends perpendicularly or substantially perpendicularly (for example within 5° of perpendicular) to the length of the arcuate projection. The floor surface 70 has a width W_{F} extending parallel or substantially parallel (for example within 5° of parallel) to the longitudinal axis 52. The width W_{3RD} of the third mating surface 104 may be less than the width W_{F} of the floor surface 70 of the groove 60 thereby creating clearance between the first groove side surface 64 and the first mating surface 100 and/or the second groove side surface 68 and the second mating surface 102. Practical embodiments for the interface of the arcuate projection 94 with groove 60 disclosed herein include embodiments where the first mating surface 100 engages the first groove side surface 64 where the second mating surface 102 engages the second groove side surface 68, where both mating surfaces engage respective groove side surfaces, where one or the other of the mating surfaces engage their respective side surfaces, and where the arcuate projection is received within groove 60 but neither mating surface engages either groove side surface. Similarly, practical embodiments of the interface of the arcuate projection 94 with groove 60 disclosed herein include embodiments where third mating surface 103 engages floor surface 70 of the groove 60, and embodiments where such engagement does not occur. Selection of whether any surfaces of the arcuate projection 94 engage groove 60 is a matter of engineering choice related to the degree of rigidity or flexibility desired in the assembled grooved joint.

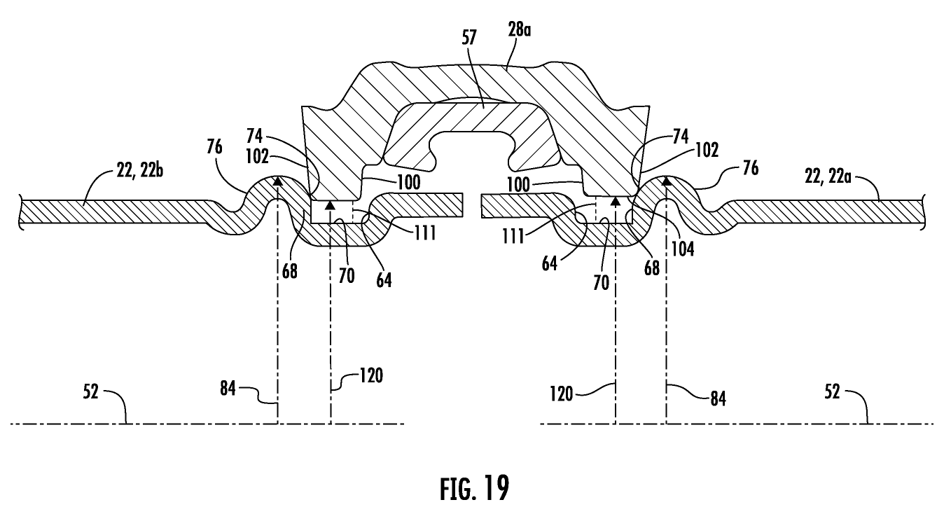

As shown in FIGS. 18-21, the plurality of segments 28a, 28b are configured to be drawn towards one another from an initial condition (shown in FIGS. 18-20) (optionally a preassembled condition (shown in FIGS. 18 and 19)) to a tightened condition (shown in FIGS. 1, 21, and 26). As shown in FIGS. 18 and 19, in the initial condition, the third mating surface 104 is spaced from the floor surface 70 of the groove 60 by a first distance 111. As shown in FIG. 21, in the tightened condition, the third mating surface 104 engages the floor surface 70 of the groove 60 or, optionally, the third mating surface 104 is spaced from the floor surface 70 of the groove 60 by a second distance 113. The second distance 113 is less than the first distance 111 and may be zero.

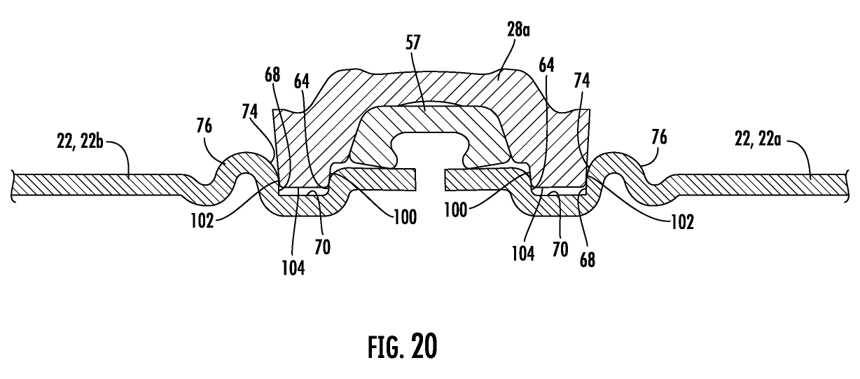

As shown in FIGS. 18-21, as the segments 28a, 28b are drawn together from the initial condition (shown in FIGS. 18-20) to the tightened condition (shown in FIG. 20), the arcuate projection 94 engages with the groove 60. In the tightened condition, the arcuate projection 94 may engage at least one of the first groove side surface 64, the second groove side surface 68, and the floor surface 70. In the tightened condition, the arcuate projection 94 may be received within the groove 60 in a manner that provides for clearance between arcuate projection mating surfaces 100, 102 and groove side surfaces 64, 68 upon assembly of the coupling. As shown in FIGS. 1 and 26, in the tightened condition, stop surfaces 42 may engage each other, and may serve as final visual confirmation that the coupling 20, 20’ has been properly installed and is in the tightened condition. As shown in FIGS. 22 and26, stop surfaces are shown as flat pads; however, the disclosure is not so limited and the stop surfaces may take the form of slanted pads, tongue and recess, and other known interfaces. Optionally, in the tightened condition, the stop surfaces 42 may be separated by a gap, with confirmation of proper installation of coupling 20, 20’ being provided by application of appropriate torque to fasteners 44, or where the gap between the stop surfaces 42 is within an acceptable range.

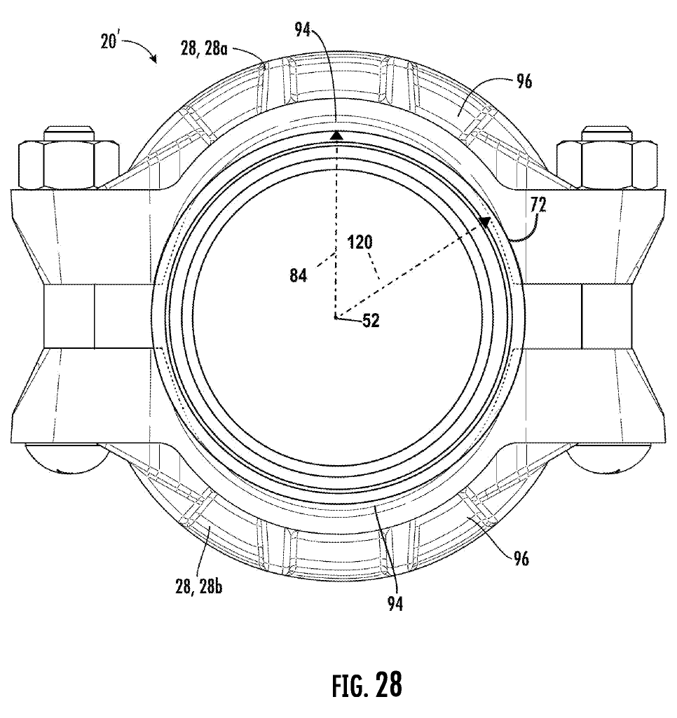

FIGS. 18 and 19 show, in detail, an exemplary cross-sectional geometry of the arcuate projections 94 and endform 80 of each pipe element 22a, 22b initially upon insertion of the pipe elements 22a, 22b in the central space 30 when the coupling 20, 20’ is in the preassembled state. The geometry of the arcuate projection 94 and the endform 80 of the pipe element 22 may facilitate alignment and engagement of the arcuate projection 94 and respective groove 60. The geometry of the arcuate projection 94 and the endform 80 of the pipe element 22 facilitates alignment and engagement between a groove 60 and arcuate projection 94 of a coupling 20, 20’ that does not rely upon engagement between a tongue or center leg of the seal 57 with endform 80, and without requiring manual alignment of the arcuate projection and groove. As shown in FIG. 19, the bead 72 has a radius 84 that causes the pipe element 22 to engage a portion of the coupling 20, 20’ to prevent the pipe element 22 from moving farther into the central space 30 and to align the groove 60 of the pipe element with respect to the arcuate projection 94. As shown in FIG. 19, in a cross-sectional plane including the longitudinal axis 52, the radius 84 of the summit 78 may be greater than a linear distance 120 measured from the longitudinal axis 52 to at least a portion of the third mating surface 104 of the arcuate projection 94, the linear distance 120 extending along an axis parallel or substantially parallel (for example within 5° of parallel) to the radius 84 of the summit 78, when the coupling 20, 20’ is in the preassembled state such that the coupling 20, 20’ engages the second groove side surface 68 and/or the first bead side surface 74 and the pipe element 22 is prevented from moving farther into the central space 30. As shown in FIG. 28 (gasket 57 and certain details of pipe element 22 are not shown for clarity), because the segments 28 are offset from the longitudinal axis 52 in the preassembled state, the bead 72 may only contact a portion of the coupling 20, 20’ (coupling 20’ shown). In some embodiments, including as depicted in FIG. 19, the arcuate projection 94 (in this example, the second mating surface 102 of the arcuate projection 94) engages with bead 72. The geometry of the arcuate projection 94, including the second mating surface 102, and the geometry of the bead 72 and groove 60, including the second groove side surface 68 and/or the first bead side surface 74, may be designed to force the pipe element 22 to move axially outward from the central space 30 as the arcuate projection 94 slides radially inwardly towards the central space along the second groove side surface 68 and/or the first bead side surface 74 to align and facilitate the arcuate projection 94 being received within the groove 60.

A method of assembling a combination of the pipe element 22 and the coupling 20, 20’ comprises inserting the pipe element 22 end first into the central space 30 of the coupling 20, 20’ in the preassembled state until at least one of the groove 60 and the bead 72 engages coupling 20, 20’. In some aspects, inserting the pipe element 22 comprises inserting the pipe element 22 until at least one of the second groove side surface 68 and the first bead side surface 74 engages the arcuate projection 94 of the coupling 20, 20’. The groove 60 may comprise a first groove side surface 64, a second groove side surface 68 facing the first groove side surface 64 and in spaced apart relation from the first groove side surface 64, and a floor surface 70 contiguous with the first groove side surface 64 and the second groove side surface 68. The bead 72 may comprise a first bead side surface 74and a summit 78, wherein the first bead side surface 74 is positioned between the summit 78 and the second groove side surface 68. The arcuate projection may comprise a first mating surface 100, a second mating surface 102 facing away from the first mating surface 100, and a third mating surface 104 contiguous with the first mating surface 100 and the second mating surface 102 and facing the central space 30, the third mating surface 104 positioned between the first mating surface 100 and the second mating surface 102. Optionally, the first bead side surface 74 is adjacent or contiguous with the second groove side surface 68.

The method comprises adjusting the attachment members 36 to draw the plurality of segments 28a, 28b from the initial condition to the tightened condition. Adjusting the attachment members 36 may draw the plurality of segments 28a, 28b together to the arcuate projection 94 within the groove 60. Adjusting the attachment members 36 may draw the plurality of segments 28a, 28b together such that the arcuate projection 94 may be received within the groove 60 in a manner that provides for contact or clearance between arcuate projection mating surfaces 100, 102 and groove side surfaces 64, 68 respectively, upon assembly of the coupling. The bead 72 may comprise a summit 78 having a radius 84 measured from the longitudinal axis 52, and the radius 84 of the summit 78 may be greater than a linear distance 120 measured from the longitudinal axis 52 to at least a portion of the third mating surface 104 of the arcuate projection 94 when the coupling 20, 20’ is in the preassembled state such that the pipe element 22 is prevented from moving further into the central space 30 upon the engagement of at least one of the groove 60 and the bead 72 with the arcuate projection 94. Adjusting the attachment members 36 draws the plurality of segments 28a, 28b together to a tightened condition, wherein the arcuate projection 94 slides along at least one of the groove 60 and the bead 72 as the attachment members 36 are adjusted to align the arcuate projection 94 and the groove 60.

The coupling 20, 20’ may comprise a ring seal 57, and the ring seal 57 may not comprise a tongue or center leg. Although not necessary for the alignment of the respective groove and arcuate projection, the ring seal may comprise a tongue or center leg. A geometry of the arcuate projection 94 and the endform 80 of the pipe element 22 may facilitate alignment and mechanical engagement between the groove 60 and the arcuate projection 94 without requiring manual alignment of the arcuate projection 94 and the groove 60 or engagement by the pipe element 22 with a tongue or center leg of the ring seal (if present).

### Roller Sets

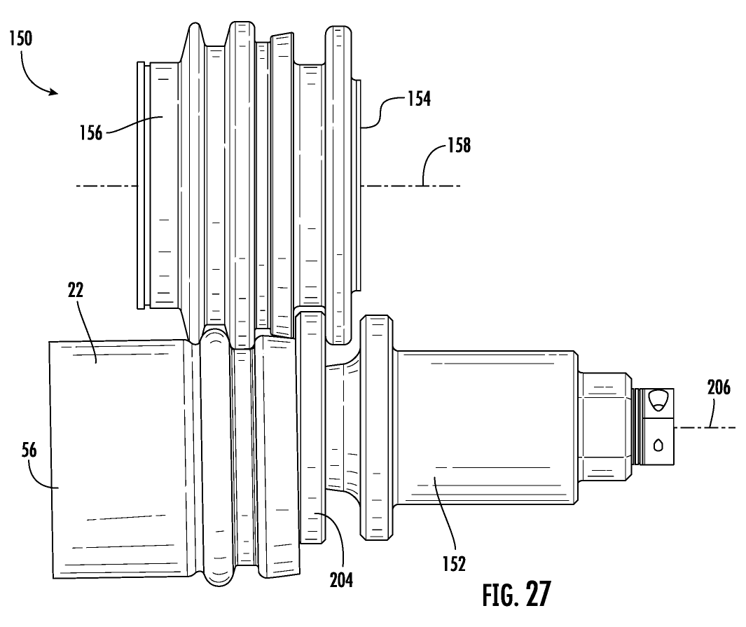

As shown in FIG. 27, roller set 150 may be used to form the endform 80 of the pipe element 22. The roller set 150 comprises an outer roller 154 engageable with the outer surface 56 of a pipe element 22. The outer roller 154 comprises an outer roller body 156 rotatable about a first axis 158. The roller set 150 comprises an inner roller 152 engageable with an inner surface 151 (shown in FIGS. 1 and 26) of the pipe element 22. The inner roller 152 comprises an inner roller body 204 rotatable about a second axis 206. The inner roller 152 and the outer roller 154 are configured to align and cooperate to form the endform 80 of the pipe element 22. In an aligned configuration, the first axis 158 and the second axis 206 are parallel or substantially parallel (within about 5° of parallel).

The inner roller 152 is a driven roller and the outer roller 154 is an idler. The outer roller 154 is configured to move toward and away from the inner roller 152. With the outer roller 154 moved away from the inner roller 152, the inner surface of the pipe element 22 is positioned on the inner roller 152. With the first axis 158 of the outer roller 154 and the second axis 206 of the inner roller 152 substantially parallel to one another, the outer roller 154 is moved into contact with the outer surface 56 of the pipe element 22. Rotation is effected by driving the inner roller 152 about the second axis 206, which causes the pipe element 22 and the outer roller 154 to rotate about the longitudinal axis 52 and the first axis 158 respectively. As the rollers and the pipe element 22 rotate, the roller bodies deform the pipe element 22, thereby roll forming the endform 80 of the pipe element 22. Formation of the endform 80 retains the pipe element 22 in engagement with the roller set 150 during roll forming by mechanical engagement. After the pipe element 22 is formed, the outer roller 154 is moved away from the inner roller 152 and the pipe element 22 is disengaged from the inner roller 152.

The endform 80 formed by the roller set 150 comprises a groove 60 defined by the outer surface 56, the groove 60 extending circumferentially around the bore 54. The groove 60 comprises a first groove side surface 64, a second groove side surface 68 facing the first groove side surface 64 and in spaced apart relation from the first groove side surface 64, and a floor surface 70 contiguous with the first groove side surface 64 and the second groove side surface 68. The endform 80 formed by the roller set 150 further comprises a bead 72 defined by the outer surface 56. Optionally, the bead 72 is adjacent or contiguous with the groove 60. The bead 72 comprises a first bead side surface 74, wherein the first bead side surface 74 is positioned between the summit 78 and the second groove side surface 68.

A method of forming a pipe element 22 having a sidewall 50 surrounding a longitudinal axis 52 and defining a bore 54, the longitudinal axis 52 being a central axis of the pipe element 22, the sidewall 50 having an outer surface 56 and an inner surface, comprises positioning the inner surface of the pipe element 22 on an inner roller 152 of a roller set 150, the inner roller 152 comprising an inner roller body 204 rotatable about a second axis 206. The method further comprises moving an outer roller 154 of the roller set 150 into contact with the outer surface 56 of the pipe element 22, the outer roller 154 comprising an outer roller body 156 rotatable about a first axis 158. The method further comprises rotating the inner roller 152, thereby rotating the pipe element 22 and the outer roller 154. The method further comprises forcing the inner roller 152 and the outer roller 154 toward one another to deform the pipe element 22 to form an endform 80.

The endform 80 comprises a groove 60 defined by the outer surface 56, the groove 60 extending circumferentially around the bore 54. The groove 60 may comprise, in a cross-sectional plane including the longitudinal axis 52, a first groove side surface 64, a second groove side surface 68 facing the first groove side surface 64 and in spaced apart relation from the first groove side surface 64, and a floor surface 70 contiguous with the first groove side surface 64 and the second groove side surface 68. The endform 80 further comprises a bead 72 defined by the outer surface 56. Optionally, the bead 72 is adjacent or contiguous with the groove 60. The bead 72 comprises a first bead side surface 74 and a summit 78, wherein the first bead side surface 74 is positioned between the summit 78 and the second groove side surface 68. Optionally, the first bead side surface 74 is adjacent or contiguous with the second groove side surface 68.

### Conclusion

It is expected that the example pipe elements and couplings described herein address one or more of the challenges associated with aligning couplings and pipe elements by providing one or more of the following features:
(1) The engagement between the bead and the arcuate projection during insertion will allow couplings and pipe elements to be properly aligned without using ring seals with tongues or center legs and without necessitating manual alignment;
(2) The engagement between the bead and the arcuate projection during insertion will reduce the risk of misassembly; and/or
(3) Removing the need for ring seals with center legs and tongues will allow for thinner and/or lighter couplings.

All of the embodiments of the claimed disclosure described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A pipe element having a sidewall surrounding a longitudinal axis and defining a bore, said longitudinal axis being a central axis of said pipe element, said sidewall having an outer surface, said sidewall comprising:

an endform; and

a tubular portion connected to said endform, wherein said endform extends from an end of said pipe element to said tubular portion; wherein said endform comprises:

a groove defined by said outer surface, said groove extending circumferentially around said bore, said groove comprising:

a first groove side surface,

a second groove side surface facing said first groove side surface and in spaced apart relation from said first groove side surface along said longitudinal axis, wherein said first groove side surface is positioned between said end of said pipe element and said second groove side surface, and

a floor surface contiguous with said first groove side surface and said second groove side surface; and

a bead defined by said outer surface, said bead extending circumferentially around said bore, said bead adjacent or contiguous with said groove, wherein said groove is positioned between said end of said pipe element and said bead, said bead comprising:

a first bead side surface, and

a summit, wherein said first bead side surface is positioned between said summit and said second groove side surface.

Aspect 2: The pipe element according to any one of the preceding aspects, wherein a radius of said summit measured from said longitudinal axis is greater than any other radius of said outer surface of said endform measured from said longitudinal axis.

Aspect 3: The pipe element according to any one of the preceding aspects, wherein a radius of said summit measured from said longitudinal axis is greater than a maximum radius of said tubular portion measured from said longitudinal axis.

Aspect 4: The pipe element according to any one of the preceding aspects, wherein a radius of said summit measured from said longitudinal axis is a maximum radius of said outer surface of a portion of said sidewall extending from said end of said pipe element to said summit measured from said longitudinal axis.

Aspect 5: The pipe element according to any one of the preceding aspects, wherein said first bead side surface is contiguous with said second groove side surface.

Aspect 6: The pipe element according to any one of the preceding aspects, wherein said first groove side surface is oriented at a first groove side angle relative to said floor surface and said second groove side surface is oriented at a second groove side angle relative to said floor surface.

Aspect 7: The pipe element according to aspect 6, wherein said second groove side surface and said first bead side surface are oriented at the same or substantially the same angle relative to said floor surface.

Aspect 8: The pipe element according to any one of aspects 6 to 7, wherein said second groove side angle is greater than said first groove side angle.

Aspect 9: The pipe element according to any one of aspects 6 to 8, wherein said first groove side angle is an obtuse angle.

Aspect 10: The pipe element according to any one of aspects 6 to 9, wherein said second groove side angle is an obtuse angle.

Aspect 11: The pipe element according to any one of the preceding aspects, wherein said bead further comprises a second bead side surface extending from said summit toward said tubular portion.

Aspect 12: The pipe element according to aspect 11, wherein said second bead side surface has a larger radius measured from said longitudinal axis at a point closer to said summit than at a point farther from said summit.

Aspect 13: The pipe element according to any one of aspects 11 to 12, wherein said tubular portion is adjacent or contiguous with said second bead side surface.

Aspect 14: The pipe element according to any one of aspects 11 to 13, wherein said endform further comprises an indent contiguous with said second bead side surface.

Aspect 15: The pipe element according to aspect 14, wherein said indent is positioned adjacent or contiguous with said tubular portion.

Aspect 16: The pipe element according to any one of aspects 14 to 15, wherein said indent comprises indicia identifying a model number or source of said pipe element.

Aspect 17: The pipe element according to any one of the preceding aspects, wherein said summit is positioned between said first bead side surface and a second bead side surface.

Aspect 18: The pipe element according to any one of the preceding aspects, wherein said first bead side surface extends from said second groove side surface to said summit.

Aspect 19: The pipe element according to any one of the preceding aspects, wherein said first bead side surface comprises a base end that is closer to said floor surface of said groove than to said summit.

Aspect 20: The pipe element according to any one of the preceding aspects, wherein said endform further comprises a sealing surface positioned between said first groove side surface and said end of said pipe element.

Aspect 21: The pipe element according to aspect 20, wherein said sealing surface extends from said first groove side surface to said end of said pipe element.

Aspect 22: The pipe element according to any one of aspects 20 to 21, wherein said sealing surface is frustoconical.

Aspect 23: The pipe element according to aspect 22, wherein a radius of said sealing surface measured from said longitudinal axis at a first point is less than a radius of said sealing surface measured from said longitudinal axis at a second point, wherein said first point is closer to said end of said pipe element than said second point to said end of said pipe element.

Aspect 24: The pipe element according to any one of aspects 22 to 23, wherein a radius of said sealing surface measured from said longitudinal axis at a first point is larger than a radius of said sealing surface measured from said longitudinal axis at a second point, wherein said first point is closer to said end of said pipe element than said second point to said end of said pipe element.

Aspect 25: The pipe element according to any one of aspects 20 to 24, wherein said sealing surface is cylindrical or substantially cylindrical.

Aspect 26: The pipe element according to any one of the preceding aspects, wherein said pipe element is a thin wall pipe.

Aspect 27: The pipe element according to any one of the preceding aspects, wherein said pipe element is a stainless steel pipe.

Aspect 28: In combination, a pipe element and a coupling in a preassembled state, said pipe element having a sidewall surrounding a longitudinal axis and defining a bore, said longitudinal axis being a central axis of said pipe element, said sidewall having an outer surface, said sidewall comprising:

an endform; and

a tubular portion connected to said endform, wherein said endform extends from an end of said pipe element to said tubular portion; wherein said endform comprises:

a groove defined by said outer surface, said groove extending circumferentially around said bore, said groove comprising:

a first groove side surface,

a second groove side surface facing said first groove side surface and in spaced apart relation from said first groove side surface, wherein said first groove side surface is positioned between said end of said pipe element and said second groove side surface, and

a floor surface contiguous with said first groove side surface and said second groove side surface; and

a bead defined by said outer surface, said bead extending circumferentially around said bore, said bead adjacent or contiguous with said groove, said bead comprising:

a first bead side surface, and

a summit, wherein said first bead side surface is positioned between said summit and said second groove side surface,

said coupling comprising:

a plurality of segments attached to one another end to end surrounding a central space;

attachment members positioned at each end of said segments for attaching said segments to one another; and

an arcuate projection positioned on a side of each of said segments and configured to engage with said groove, said arcuate projection projecting radially inwardly from said side.

Aspect 29: The combination according to aspect 28, wherein said arcuate projection comprises:

a first mating surface,

a second mating surface facing away from said first mating surface, and

a third mating surface contiguous with said first mating surface and said second mating surface and facing said central space, said third mating surface positioned between said first mating surface and said second mating surface.

Aspect 30: The combination according to aspect 29, wherein said radius of said summit measured from said longitudinal axis is greater than a distance measured from said longitudinal axis to said third mating surface of said arcuate projection, said distance extending along an axis parallel or substantially parallel to said radius of said summit.

Aspect 31: The combination according to any one of aspects 28 to 30, wherein said plurality of segments are attached to one another end to end in a preassembled state, wherein in said preassembled state, said plurality of segments are supported in spaced relation while attached to one another to allow insertion of said pipe element into said central space.

Aspect 32: The combination according to aspect 31, wherein said arcuate projection comprises:

a first mating surface,

a second mating surface facing away from said first mating surface, and

a third mating surface contiguous with said first mating surface and said second mating surface and facing said central space, said third mating surface positioned between said first mating surface and said second mating surface.

Aspect 33: The combination according to aspect 32, wherein, when said end of said pipe element is inserted into said central space of said coupling in said preassembled state, said radius of said summit measured from said longitudinal axis is greater than a linear distance measured from said longitudinal axis to said third mating surface of said arcuate projection, said distance extending along an axis parallel or substantially parallel to said radius of said summit such that said arcuate projection engages at least one of said second groove side surface and said first bead side surface and said pipe element is prevented from moving farther into said central space.

Aspect 34: The combination according to any one of aspects 31 to 33, wherein said coupling comprises a ring seal configured to support said plurality of segments in said preassembled state.

Aspect 35: The combination according to any one of aspects 28 to 34, wherein said plurality of segments comprises a first segment and a second segment, wherein said first segment and said second segment are attached to one another at one end by a hinge and at an opposite end by an adjustable fastener.

Aspect 36: The combination according to any one of aspects 28 to 35, wherein said plurality of segments comprises more than two segments attached to one another end to end to form a loop around said central space.

Aspect 37: The combination according to any one of aspects 28 to 36, wherein said plurality of segments comprises a first segment and a second segment, wherein said first segment and said second segment are attached to one another at both ends by adjustable fasteners.

Aspect 38: The combination according to any one of aspects 28 to 37, wherein each of said segments comprises lugs projecting from opposite ends of each segment, each lug comprising a stop surface, wherein in a tightened condition, said stop surfaces on respective ends of said segments engage each other.

Aspect 39: The combination according to any one of aspects 28 to 38, wherein said coupling comprises a ring seal configured to be captured and compressed between said segments and said pipe element when said attachment members are tightened.

Aspect 40: The combination according to aspect 39, wherein said ring seal does not comprise a tongue or center leg.

Aspect 41: The combination according to any one of aspects 29 to 40, wherein said plurality of segments are configured to be drawn towards one another to a tightened condition.

Aspect 42: The combination according to aspect 41, wherein in said tightened condition, said arcuate projection is received within said groove.

Aspect 43: The combination according to aspect 42, wherein in said tightened condition, said first mating surface engages said first groove side surface.

Aspect 44: The combination according to any one of aspects 42 to 43, wherein in said tightened condition, said second mating surface engages said second groove side surface.

Aspect 45: The combination according to any one of aspects 42 to 44, wherein in said tightened condition, said third mating surface engages said floor surface.

Aspect 46: The combination according to any one of aspects 29 to 45, wherein said first mating surface tapers towards said second mating surface and said second mating surface tapers towards said first mating surface such that a base of said arcuate projection is wider than a width of said third mating surface.

Aspect 47: The combination according to any one of aspects 28 to 46, wherein said pipe element is a thin wall pipe.

Aspect 48: The combination according to any one of aspects 28 to 47, wherein said pipe element is a stainless steel pipe.

Aspect 49: A method of assembling a combination of a pipe element and a coupling, said pipe element having a sidewall surrounding a longitudinal axis and defining a bore, said longitudinal axis being a central axis of said pipe element, said sidewall having an outer surface comprising an endform proximate an end of said pipe element, said endform comprising a groove defined by said outer surface, said groove extending circumferentially around said bore, said endform further comprising a bead defined by said outer surface, said bead adjacent or contiguous with said groove; said coupling comprising a plurality of segments attached to one another end to end in a preassembled state to surround a central space, wherein in said preassembled state, said plurality of segments are supported in spaced relation while attached to one another to allow insertion of said pipe element into said central space, said coupling further comprising attachment members for attaching said segments to one another, and an arcuate projection positioned on a side of each of said segments, said arcuate projection projecting radially inwardly from said side; said method comprising:

inserting said pipe element end first into said central space of said coupling in said preassembled state until at least one of said groove and said bead engages said arcuate projection.

Aspect 50: The method according to aspect 49, wherein said groove comprises a first groove side surface, a second groove side surface facing said first groove side surface and in spaced apart relation from said first groove side surface, and a floor surface contiguous with said first groove side surface and said second groove side surface.

Aspect 51: The method according to aspect 50, wherein said bead comprises a first bead side surface and a summit, wherein said groove is positioned between said end of said pipe element and said bead and said first bead side surface is positioned between said summit and said second groove side surface.

Aspect 52: The method according to aspect 50, wherein inserting said pipe element comprises inserting said pipe element until at least one of said second groove side surface and said first bead side surface engages said arcuate projection.

Aspect 53: The method according to any one of aspects 50-52, wherein said arcuate projection comprises a first mating surface, a second mating surface facing away from said first mating surface, and a third mating surface contiguous with said first mating surface and said second mating surface and facing said central space, said third mating surface positioned between said first mating surface and said second mating surface.

Aspect 54: The method according to aspect 53, further comprising adjusting said attachment members to draw said plurality of segments together to engage at least one of said first mating surface of said arcuate projection and said first groove side surface of said groove, said second mating surface of said arcuate projection and said second groove side surface of said groove, or said third mating surface of said arcuate projection and said floor of said groove.

Aspect 55: The method according to aspect 54, wherein said attachment members are adjusted to draw said plurality of segments together to engage at least two of said first mating surface of said arcuate projection and said first groove side surface of said groove, said second mating surface of said arcuate projection and said second groove side surface of said groove, or said third mating surface of said arcuate projection and said floor of said groove.

Aspect 56: The method according to any one of aspects 53 to 55, wherein said bead comprises a summit having a radius measured from said longitudinal axis, and wherein said radius of said summit is greater than a linear distance measured from said longitudinal axis to at least a portion of said third mating surface of said arcuate projection when said coupling is in said preassembled state and said end of said pipe element is inserted into said central space such that said pipe element is prevented from moving further into said central space upon said engagement of at least one of said groove and said bead with said arcuate projection.

Aspect 57: The method according to any one of aspects 49 to 56, further comprising adjusting said attachment members to draw said plurality of segments together to a tightened condition, wherein said arcuate projection slides along at least one of said groove and said bead as said attachment members are adjusted to align said arcuate projection and said groove.

Aspect 58: The method according to any one of aspects 49 to 57, wherein said coupling comprises a ring seal, and wherein said ring seal does not comprise a tongue or center leg.

Aspect 59: The method according to any one of aspects 49 to 58, wherein a geometry of said arcuate projection and said endform of said pipe element facilitates alignment and mechanical engagement between said groove and said arcuate projection without requiring manual alignment of said arcuate projection and said groove.

Aspect 60: The method according to any one of aspects 49 to 59, wherein said pipe element is a thin wall pipe.

Aspect 61: The method according to any one of aspects 49 to 60, wherein said pipe element is a stainless steel pipe.

Aspect 62: A method of forming a pipe element having a sidewall surrounding a longitudinal axis and defining a bore, said longitudinal axis being a central axis of said pipe element, said sidewall having an outer surface and an inner surface, said method comprising:

positioning said inner surface of said pipe element on an inner roller of a roller set, said inner roller comprising an inner roller body rotatable about a second axis;

moving an outer roller of said roller set into contact with said outer surface of said pipe element, said outer roller comprising an outer roller body rotatable about a first axis;

rotating said inner roller, thereby rotating said pipe element and said outer roller; and

forcing said inner and outer rollers toward one another to deform said pipe element to form an endform comprising:

a groove defined by said outer surface proximate an end of said pipe element, said groove extending circumferentially around said bore, said groove comprising a first groove side surface, a second groove side surface facing said first groove side surface and in spaced apart relation from said first groove side surface, and a floor surface contiguous with said first groove side surface and said second groove side surface; and

a bead defined by said outer surface, said bead adjacent or contiguous with said groove, said bead comprising a first bead side surface and a summit, wherein said groove is positioned between said end of said pipe element and said bead and said first bead side surface is positioned between said summit and said second groove side surface.

Aspect 63: The combination according to any one of aspects 28-48, wherein a radius of said summit of said pipe element measured from said longitudinal axis is a maximum radius of said outer surface of a portion of said sidewall extending from said end of said pipe element to said summit measured from said longitudinal axis.

Aspect 64: The combination according to any one of aspects 28-48 or 63, wherein said attachment members are positioned at each end of said segments and attach said segments to one another in said preassembled state, wherein in said preassembled state, said plurality of segments are supported in spaced relation while attached to one another to allow insertion of said pipe element into said central space.

Aspect 65: The combination according to aspect 64, wherein, when said end of said pipe element is inserted into said central space of said coupling in said preassembled state, said radius of said summit is greater than a linear distance measured from said longitudinal axis to at least a portion of said arcuate projection of said coupling such that said arcuate projection engages at least one of said second groove side surface and said first bead side surface and said pipe element is prevented from moving farther into said central space.

What is claimed is:

1. A pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface, said groove extending circumferentially around said bore, said groove comprising:
a first groove side surface,
a second groove side surface facing said first groove side surface and in spaced apart relation from said first groove side surface along said longitudinal axis, wherein said first groove side surface is positioned between said end of said pipe element and said second groove side surface, and
a floor surface contiguous with said first groove side surface and said second groove side surface; and
a bead defined by said outer surface, said bead extending circumferentially around said bore, said bead adjacent or contiguous with said groove, wherein said groove is positioned between said end of said pipe element and said bead, said bead comprising:
a first bead side surface, and
a summit, wherein said first bead side surface is positioned between said summit and said second groove side surface, wherein a radius of said summit measured from said longitudinal axis is a maximum radius of said outer surface of a portion of said sidewall extending from said end of said pipe element to said summit measured from said longitudinal axis.

2. The pipe element according to claim 1, wherein said radius of said summit measured from said longitudinal axis is greater than any other radius of said outer surface of said endform measured from said longitudinal axis.

3. The pipe element according to claim 1, wherein said radius of said summit measured from said longitudinal axis is greater than a maximum radius of said tubular portion measured from said longitudinal axis.

4. The pipe element according to claim 1, wherein said first bead side surface is contiguous with said second groove side surface.

5. The pipe element according to claim 1, wherein said first groove side surface is oriented at a first groove side angle relative to said floor surface and said second groove side surface is oriented at a second groove side angle relative to said floor surface, wherein said second groove side angle is greater than said first groove side angle.

6. The pipe element according to claim 5, wherein said first groove side angle is an obtuse angle.

7. The pipe element according to claim 1, wherein said bead further comprises a second bead side surface extending from said summit toward said tubular portion, wherein said endform further comprises an indent contiguous with said second bead side surface.

8. The pipe element according to claim 1, wherein said first bead side surface extends from said second groove side surface to said summit.

9. The pipe element according to claim 1, wherein said endform further comprises a sealing surface positioned between said first groove side surface and said end of said pipe element.

10. The pipe element according to claim 9, wherein said sealing surface extends from said first groove side surface to said end of said pipe element.

11. The pipe element according to claim 9, wherein said sealing surface is frustoconical.

12. The pipe element according to claim 9, wherein said sealing surface is cylindrical or substantially cylindrical.

13. In combination, a pipe element and a coupling in a preassembled state, said pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface, said groove extending circumferentially around said bore, said groove comprising:
a first groove side surface,
a second groove side surface facing said first groove side surface and in spaced apart relation from said first groove side surface, wherein said first groove side surface is positioned between said end of said pipe element and said second groove side surface, and
a floor surface contiguous with said first groove side surface and said second groove side surface; and
a bead defined by said outer surface, said bead extending circumferentially around said bore, said bead adjacent or contiguous with said groove, said bead comprising:
a first bead side surface, and
a summit, wherein said first bead side surface is positioned between said summit and said second groove side surface, wherein a radius of said summit measured from said longitudinal axis is a maximum radius of said outer surface of a portion of said sidewall extending from said end of said pipe element to said summit measured from said longitudinal axis;
said coupling comprising:
a plurality of segments attached to one another end to end surrounding a central space;
attachment members positioned at each end of said segments attaching said segments to one another in said preassembled state, wherein in said preassembled state, said plurality of segments are supported in spaced relation while attached to one another to allow insertion of said pipe element into said central space; and
an arcuate projection positioned on a side of each of said segments and configured to engage with said groove, said arcuate projection projecting radially inwardly from said side.

14. The combination according to claim 13, wherein, when said end of said pipe element is inserted into said central space of said coupling in said preassembled state, said radius of said summit is greater than a linear distance measured from said longitudinal axis to at least a portion of said arcuate projection of said coupling such that said arcuate projection engages at least one of said second groove side surface and said first bead side surface and said pipe element is prevented from moving farther into said central space.

15. The combination according to claim 13, wherein said arcuate projection comprises:
a first mating surface,
a second mating surface facing away from said first mating surface, and
a third mating surface contiguous with said first mating surface and said second mating surface and facing said central space, said third mating surface positioned between said first mating surface and said second mating surface.

16. The combination according to claim 15, wherein, when said end of said pipe element is inserted into said central space of said coupling in said preassembled state, said radius of said summit measured from said longitudinal axis is greater than a linear distance measured from said longitudinal axis to said third mating surface of said arcuate projection, said distance extending along an axis parallel or substantially parallel to said radius of said summit such that said arcuate projection engages at least one of said second groove side surface and said first bead side surface and said pipe element is prevented from moving farther into said central space.

17. The combination according to claim 13, wherein said coupling comprises a ring seal configured to support said plurality of segments in said preassembled state.

18. The combination according to claim 13, wherein said plurality of segments comprises a first segment and a second segment, wherein said first segment and said second segment are attached to one another at one end by a hinge and at an opposite end by an adjustable fastener.

19. The combination according to claim 13, wherein said plurality of segments comprises more than two segments attached to one another end to end to surround said central space.

20. The combination according to claim 13, wherein said plurality of segments comprises a first segment and a second segment, wherein said first segment and said second segment are attached to one another at both ends by adjustable fasteners.

21. The combination according to claim 13, wherein each of said segments comprises lugs projecting from opposite ends of each segment, each lug comprising a stop surface, wherein in a tightened condition, said stop surfaces on respective ends of said segments engage each other.

22. The combination according to claim 13, wherein said coupling comprises a ring seal configured to be captured and compressed between said segments and said pipe element when said attachment members are tightened.

23. The combination according to claim 22, wherein said ring seal does not comprise a tongue or center leg.

24. The combination according to claim 15, wherein said plurality of segments are configured to be drawn towards one another to a tightened condition.

25. The combination according to claim 24, wherein in said tightened condition, said first mating surface engages said first groove side surface.

26. The combination according to claim 24, wherein in said tightened condition, said second mating surface engages said second groove side surface.

27. The combination according to claim 24, wherein in said tightened condition, said third mating surface engages said floor surface.

28. A method of assembling a combination of a pipe element and a coupling, said pipe element having a sidewall surrounding a longitudinal axis and defining a bore, said longitudinal axis being a central axis of said pipe element, said sidewall having an outer surface comprising an endform proximate an end of said pipe element, said endform comprising a groove defined by said outer surface, said groove extending circumferentially around said bore, said endform further comprising a bead defined by said outer surface, said bead adjacent or contiguous with said groove; said coupling comprising a plurality of segments attached to one another end to end in a preassembled state surrounding around a central space, wherein in said preassembled state, said plurality of segments are supported in spaced relation while attached to one another to allow insertion of said pipe element into said central space, said coupling further comprising attachment members for attaching said segments to one another, and an arcuate projection positioned on a side of each of said segments, said arcuate projection projecting radially inwardly from said side; said method comprising:
inserting said pipe element end first into said central space of said coupling in said preassembled state until at least one of said groove and said bead engages said arcuate projection.

29. The method according to claim 28, wherein said groove comprises:
a first groove side surface,
a second groove side surface facing said first groove side surface and in spaced apart relation from said first groove side surface, and
a floor surface contiguous with said first groove side surface and said second groove side surface.

30. The method according to claim 29, wherein said bead comprises a first bead side surface and a summit, wherein said groove is positioned between said end of said pipe element and said bead and said first bead side surface is positioned between said summit and said second groove side surface.

31. The method according to claim 30, wherein inserting said pipe element comprises inserting said pipe element until at least one of said second groove side surface and said first bead side surface engages said arcuate projection.

32. The method according to claim 29, wherein said arcuate projection comprises a first mating surface, a second mating surface facing away from said first mating surface, and a third mating surface contiguous with said first mating surface and said second mating surface and facing said central space, said third mating surface positioned between said first mating surface and said second mating surface.

33. The method according to claim 32, further comprising adjusting said attachment members to draw said plurality of segments together to engage at least one of said first mating surface of said arcuate projection and said first groove side surface of said groove, said second mating surface of said arcuate projection and said second groove side surface of said groove, or said third mating surface of said arcuate projection and said floor of said groove.

34. The method according to claim 33, wherein said bead comprises a summit having a radius measured from said longitudinal axis, and wherein said radius of said summit is greater than a linear distance measured from said longitudinal axis to said third mating surface of said arcuate projection when said coupling is in said preassembled state and said end of said pipe element is inserted into said central space such that said pipe element is prevented from moving further into said central space upon said engagement of at least one of said groove and said bead with said arcuate projection.
